(19) United States
(12) Patent Application Publication
(10) Pub. No.: US 2025/0379648 A1
(43) Pub. Date: Dec. 11, 2025

(54) Communications Systems with Messaging Over Low-Bandwidth Links

(71) Applicant: Apple Inc., Cupertino, CA (US)

(72) Inventors: Abhishek Walia, Santa Clara, CA (US); Andrew N Khoury, Sunnyvale, CA (US); Lakshmi N Kavuri, San Jose, CA (US); Manish Goyal, Cupertino, CA (US); Nelson M LeDuc, San Jose, CA (US); Venkateswara Rao Manepalli, San Jose, CA (US); Frederic Jacobs, Saint-Sulpice (CH); Gregory R Nelson, Los Altos, CA (US); Aleksey Shlyapnikov, San Jose, CA (US)

(21) Appl. No.: 18/898,349

(22) Filed: Sep. 26, 2024

Related U.S. Application Data
(60) Provisional application No. 63/657,580, filed on Jun. 7, 2024.

(51) Int. Cl. H04B 7/185; H04W 84/06

(52) U.S. Cl. CPC H04B 7/18513; H04W 84/06

(57) ABSTRACT

A communications system may include a satellite constellation and a terrestrial network. A first user equipment (UE) device may provision sender keys, handles, and/or status information with a core network while connected to the terrestrial network. The core network may accommodate server fan out to a set of other UE devices associated with a particular user identifier. When the first UE device disconnects from the terrestrial network, the first UE device and the set of other UE devices may convey end-to-end encrypted messages through the constellation and the core network. The first UE device may address the set of other UE devices using a short handle associated with the user identifier and/or using a handle index. The first UE device may transmit a control message via the constellation that instructs the core network to release provisioned status information to the set of other UE devices.

This application claims the benefit of U.S. Provisional Patent Application No. 63/657,580 filed Jun. 7, 2024, which is hereby incorporated by reference herein in its entirety.

### FIELD

This relates generally to wireless communications, including wireless communications between user equipment devices.

### BACKGROUND

Communications systems are used to convey data between terminals such as user equipment (UE) devices. A communications system can include a wireless network that wirelessly conveys data between UE devices.

In practice, some wireless networks can exhibit limited speed and/or bandwidth in conveying data between UE devices. Care should be taken to ensure that a UE device does not need to wait an excessive amount of time to successfully transmit or receive data and to ensure that the wireless network conveys the data while maintaining sufficient levels of security and user privacy.

### SUMMARY

A communications system may include a non-terrestrial network (NTN) and a terrestrial network that convey wireless data such as messages between at least first and second user equipment (UE) devices. The terrestrial network may include a core network and terrestrial-based communications equipment. The NTN may include a constellation of communications satellites. The first UE device may move between being on-grid and connected to the terrestrial network and being off-grid and disconnected from the terrestrial network. UE devices in the system may be associated with corresponding user identifiers.

The first UE device may provision sender keys, handles, and/or satellite communications (satcom) status information with the core network while the first UE device is on-grid. The first UE device may be associated with a first user identifier. The core network may accommodate server fan out from the first UE device to a set of other UE devices associated with a second user identifier. The user identifiers may include phone numbers, email addresses, profile names, or other relatively large strings of information.

When the first UE device goes off grid, the first UE device and the set of other UE devices may convey messages through the constellation and the core network. The first UE device and the set of other UE devices may use the provisioned sender keys to end-to-end encrypt the messages between the first UE device and the set of other UE devices. To reduce the size of the messages, the first UE device may address the set of other UE devices using a short handle associated with the second user identifier and/or using a handle index that is shorter than the short handle. The first UE device may use a handle assignment bit to instruct the core network to assign a particular handle index to a corresponding handle. The first UE device may transmit a control message via the constellation that instructs the core network to release provisioned satcom status information to the set of other UE devices. If desired, the messages may utilize unique effective identifiers to reference earlier transmitted or received messages (e.g., for implementing tap-back or in-line reply features). If desired, the messages may include a fetch message that instructs the core network to prioritize messages from a particular user identifier over other messages from other user identifiers for transmission to the first UE device via the constellation.

### BRIEF DESCRIPTION OF THE DRAWINGS

FIG. 1 is a diagram of an illustrative communications system including user equipment devices that communicate via a terrestrial network and a non-terrestrial network in accordance with some embodiments.

FIG. 2 is a schematic diagram of an illustrative user equipment device in accordance with some embodiments.

FIG. 3 is a schematic diagram of an illustrative communications satellite in accordance with some embodiments.

FIG. 4 is a flow chart of illustrative operations involved in conveying data between first and second user equipment devices using a communications system that includes a terrestrial network and a non-terrestrial network in accordance with some embodiments.

FIG. 5 is a diagram of an illustrative messaging application having a full feature set supported by a first protocol and having a reduced feature set supported by a second protocol in accordance with some embodiments.

FIG. 6 is a diagram of an illustrative graphical user interface that may be generated by an off-grid user equipment device to display mobile terminated and mobile originated messages in accordance with some embodiments.

FIG. 7 is a flow chart of illustrative operations involved in provisioning and utilizing cryptographic keys to transmit wireless data from a first user equipment device to a set of other user equipment devices while the first user equipment device is off-grid in accordance with some embodiments.

FIG. 8 is a diagram of an illustrative communications system showing how cryptographic keys may be provisioned and utilized to transmit wireless data from a first user equipment devices to a set of other user equipment devices in accordance with some embodiments.

FIG. 9 is a diagram showing how an illustrative user equipment device may reduce the amount of data in messages transmitted over a non-terrestrial network using handles and/or handle indices instead of full user identifiers in accordance with some embodiments.

FIG. 10 is a diagram of illustrative messages containing a handle index in accordance with some embodiments.

FIG. 11 is a flow chart of illustrative operations that may be performed by a core network and a user equipment device to conveying messages based on handle indices in accordance with some embodiments.

FIG. 12 is a flow chart of illustrative operations that may be performed by a user equipment device to convey messages without message identifier fields in accordance with some embodiments.

FIG. 13 is an illustrative diagram showing how a first user equipment device and a core network may provision and release satellite communications status message payloads for display at a second user equipment device in accordance with some embodiments.

FIG. 14 is a flow chart of illustrative operations involved in provisioning and releasing satellite communications status message payloads in accordance with some embodiments.

FIG. 15 is a flow chart of illustrative operations involved in prioritizing messages for a user equipment device based on a fetch message transmitted by the user equipment device in accordance with some embodiments.

### DETAILED DESCRIPTION

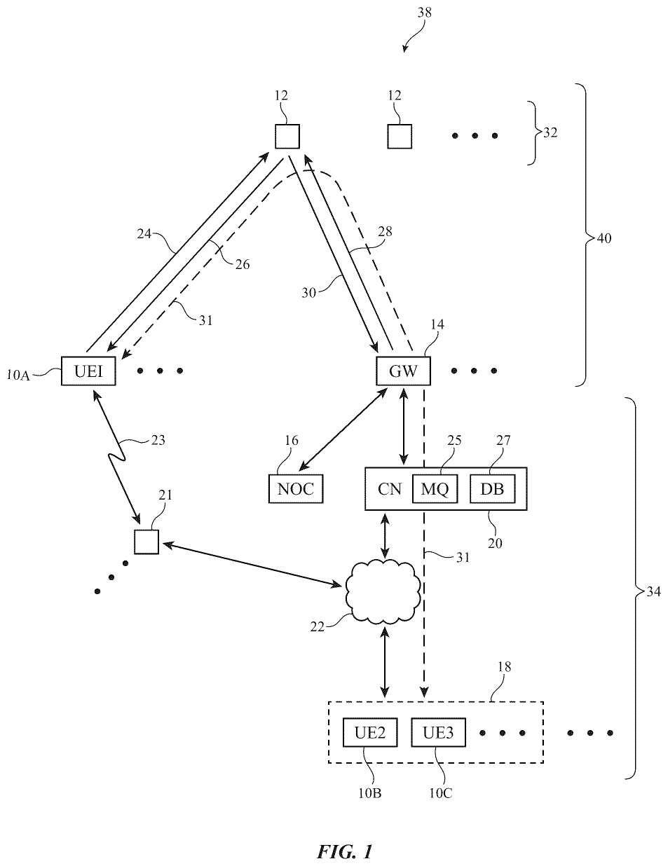

FIG. 1 is a diagram of an illustrative communications system 38. Communications system 38 (sometimes referred to herein as communications network 38, network 38, system 38, satellite communications system 38, or satellite communications network 38) may include a first network having a first maximum bandwidth such as terrestrial network 34. Communications system 38 may also include a second network having a second maximum bandwidth less than the first maximum bandwidth such as non-terrestrial network (NTN) 40.

Communications system 38 may include a set of one or more user equipment (UE) devices 10 on Earth, such as at least a first UE device 10A (sometimes denoted herein as UE1), a second UE device 10B (sometimes denoted herein as UE2), and a third UE device 10C (sometimes denoted herein as UE3). Only three UE devices are illustrated in FIG. 1 for the sake of simplicity and clarity. In general, communications system 38 may include any desired number of UE devices (e.g., hundreds, thousands, millions, billions, etc.).

The nodes of terrestrial network 34 are located on Earth. NTN 40 is a space-based network that includes nodes on Earth as well as nodes in space (e.g., in orbit around Earth). NTN 40 may include a ground-based (terrestrial) gateway system that includes one or more gateways 14. NTN 40 may also include a set of one or more UE devices 10 (e.g., UE devices configured to communicate via NTN 40) such as UE device 10A. Terrestrial network 34 may include a set of one or more UE devices 10 such as UE devices 10B and 10C. UE device 10A may form part of terrestrial network 34 when UE device 10A communicates with terrestrial-based wireless communications equipment 21 (sometimes also referred to herein as terrestrial-based communications equipment 21 or terrestrial communications equipment 21).

In some implementations, terrestrial network 34 may include a set of worldwide cellular telephone carrier networks. Each carrier network may be associated with, operated by, owned by, controlled by, and/or managed by a corresponding cellular telephone network carrier or service provider (sometimes also referred to as a mobile network operator (MNO)). Each carrier network may include a respective network of cellular base stations. Each cellular base station may provide cellular telephone coverage within a respective geographic region or area, sometimes also referred to as a cell. The cellular base stations of the carrier networks may convey radio-frequency signals with UE devices 10 in one or more cellular telephone communications bands, using one or more cellular telephone radio access technologies (RATs), and using one or more cellular telephone communications protocols. The radio-frequency signals may convey voice signals, cellular data, and Short Messaging Service (SMS) text messages. Each UE device 10 of a corresponding carrier network (e.g., UE devices 10 registered with or subscribed to the carrier network) may include a subscriber identity module (SIM) (e.g., a SIM card) associated with the carrier network and/or the MNO of the carrier network.

Terrestrial-based wireless communications equipment 21 of terrestrial network 34 may include, for example, one or more wireless base stations of a carrier network, one or more wireless access points (e.g., for implementing a wireless local area network (WLAN)), and/or other UE devices 10 (e.g., for implementing a device-to-device (D2D) network, a wireless personal area network (WPAN), etc.). UE device 10A may convey radio-frequency signals with terrestrial-based wireless communications equipment 21 over a corresponding terrestrial network wireless communication link 23 when available. UE device 10A may convey wireless data (e.g., text messages, voice data, other cellular data, etc.) over terrestrial network wireless communication link 23 using radio-frequency signals conveyed between UE device 10A and terrestrial-based wireless communications equipment 21. Terrestrial network wireless communication link 23 may be supported using cellular telephone signals, WLAN signals, WPAN signals, D2D signals, etc.

A UE device 10 is referred to herein as being “online” or “on-grid” when the UE device is within range of at least some terrestrial-based wireless communications equipment 21 and when terrestrial-based wireless communications equipment 21 provides access (e.g., communications resources) to terrestrial network 34 for the UE device. When the UE device is on-grid, the UE device may communicate with other network nodes or terminals of terrestrial network 34 via terrestrial network wireless communications link 23.

Conversely, a UE device 10 is referred to herein as being “offline” or “off-grid” when the UE device is out of range of any terrestrial-based wireless communications equipment 21 (e.g., such that a wireless performance metric characterizing communications between the UE device and the terrestrial-based wireless communications equipment is less than a threshold level) or when the UE device is in range of terrestrial-based wireless communications equipment 21 but terrestrial-based wireless communications equipment 21 does not provide the UE device with access to terrestrial network 34. In-range terrestrial-based wireless communications equipment 21 does not provide access to terrestrial network 34 for the UE device (rendering the UE device off-grid) when, for example, the in-range terrestrial-based wireless communications equipment 21 is disabled due to a power outage, natural disaster, traffic surge, or emergency, when the in-range terrestrial-based wireless communications equipment 21 denies access to terrestrial network 34 for the UE device, when the in-range terrestrial-based wireless communications equipment 21 is overloaded with other communications traffic, etc. A UE device is sometimes referred to herein as being connected to terrestrial network 34 (e.g., via terrestrial network wireless communications link 23) while on-grid. The UE device is sometimes referred to herein as being disconnected or unconnected from terrestrial network 34 while off-grid.

If desired, UE devices 10 may include separate antennas for handling communications over the satellite-to-user equipment link and one or more terrestrial network wireless communication links 23 or UE devices 10 may include a single antenna that handles both the satellite-to-user equipment link and the terrestrial network wireless communications links. The terrestrial network wireless communications links may be, for example, cellular telephone links (e.g., links maintained using a cellular telephone communications protocol such as a 4G Long Term Evolution (LTE) protocol, a 3G protocol, a 3GPP Fifth Generation (5G) New Radio (NR) protocol, a 3GPP Sixth Generation (6G) protocol, etc.), wireless local area network links (e.g., Wi-Fi® links), wireless personal area network links (e.g., Bluetooth links), D2D links, etc.

NTN 40 may include a constellation 32 of one or more communications satellites 12 in space (e.g., in orbit around Earth). Constellation 32 conveys signals between UE devices 10 and gateways 14 through space. Constellation 32 is sometimes also referred to herein as satellite constellation 32. NTN 40 may include any desired number of gateways 14, any desired number of satellites 12, and any desired number of UE devices 10. Only a single gateway (GW) 14, two satellites 12, and a single UE device 10A are shown in NTN 40 of FIG. 1 for the sake of clarity. Each gateway 14 in NTN 40 may be located at a different respective geographic location on Earth (e.g., across different regions, cities, counties, prefectures, districts, municipalities, land masses, areas, localities, states, provinces, countries, continents, etc.).

Terrestrial network 34 may be communicatively coupled to gateway 14. Gateway 14 is sometimes also referred to herein as ground station (GS) 14 or satellite network ground station 14. Gateway 14 may include one or more antennas (e.g., electronically and/or mechanically adjustable antennas), modems, transceivers, amplifiers, beam forming circuitry, control circuitry (e.g., one or more processors, storage circuitry, etc.) and other components that are used to convey communications data. The components of gateway 14 may be disposed within a building, vehicle, housing, enclosure, etc. Gateways 14 are stationary on Earth whereas UE devices 10 are mobile and move around Earth over time. Gateways 14 may convey communications data between terrestrial network 34 and UE devices 10 via constellation 32.

Terrestrial network 34 may include a network portion (region) such as network portion 22. Terrestrial network 34 and network portion 22 may include any desired number of network nodes, terminals, and/or end hosts that are communicably coupled together using communications paths that include wired and/or wireless links. The wired links may include cables (e.g., ethernet cables, optical fibers or other optical cables that convey signals using light, telephone cables, etc.). Terrestrial network 34 and network portion 22 may include one or more relay networks, mesh networks, local area networks (LANs), wireless local area networks (WLANs), ring networks (e.g., optical rings), cloud networks, virtual/logical networks, the Internet, virtual private networks (VPNs), combinations of these, and/or any other desired network nodes coupled together using any desired network topologies (e.g., on Earth). The network nodes, terminals, and/or end hosts may include network switches, network routers, optical add-drop multiplexers, other multiplexers, repeaters, modems, servers, network cards, wireless access points, wireless base stations, UE devices, and/or any other desired network components. The network nodes in terrestrial network 34 and network portion 22 may include physical components such as electronic devices, servers, computers, user equipment, etc., and/or may include virtual components that are logically defined in software and that are distributed across (over) two or more underlying physical devices (e.g., in a cloud network configuration).

Communications system 38 may include one or more satellite network operations centers such as network operations center (NOC) 16. NOC 16 may control the operation of gateways 14 in communicating with constellation 32. NOC 16 may also control the operation of the satellites 12 in constellation 32. For example, NOC 16 may convey control commands via gateways 14 that control positioning operations (e.g., orbit adjustments), sensing operations (e.g., thermal information gathered using one or more thermal sensors), and/or any other desired operations performed in space by satellites 12. NOC 16, gateways 14, and satellite constellation 32 may be operated or managed by a corresponding satellite constellation operator that is a different entity than the network carriers (MNOs) of carrier networks in terrestrial network 34.

Communications system 38 may also include a satellite communications (satcom) network service provider (e.g., a satcom network carrier or operator) for controlling wireless communications between UE devices 10 and terrestrial network 34 via constellation 32. The satcom network service provider may be a different entity than the satellite constellation operator that controls/operates NOC 16, gateways 14, and constellation 32 or, if desired, may be the same entity as the satellite constellation operator. The satcom network service provider is a different entity than the network carriers (MNOs) of the carrier networks of terrestrial network 34. The satcom network service provider may be, for example, the same entity that designs, manufactures, distributes, and/or assembles a subset of the UE devices 10 in communications system 38 and/or the operating system of the subset of UE devices 10.

One or more gateways 14 may control the operations of constellation 32 over corresponding radio-frequency communications links. Constellation 32 may include any desired number of satellites 12 (e.g., two satellites, four satellites, ten satellites, dozens of satellites, hundreds of satellites, thousands of satellites, etc.), two of which are shown in FIG. 1. If desired, two or more of the satellites 12 in constellation 32 may convey radio-frequency signals between each other using satellite-to-satellite (e.g., relay) links.

Constellation 32 may include a set of non-geostationary orbit (NGSO) satellites 12 (e.g., satellites in non-geostationary orbits) and, if desired, may include a set of geostationary orbit (GSO) satellites 12 (e.g., satellites in geostationary/geosynchronous orbits, sometimes referred to as geosynchronous satellites or GEO satellites). NGSO satellites 12 move relative to the surface of Earth over time (e.g., at non-zero velocities relative to the surface of Earth). GSO satellites 12 do not move relative to the surface of Earth (e.g., may orbit around Earth at a velocity that matches the rotation of Earth given the altitude of the satellites).

GSO satellites 12 in constellation 32 may, for example, orbit Earth at orbital altitudes of greater than around 30,000 km. NGSO satellites 12 in constellation 32 may include low earth orbit (LEO) satellites at orbital altitudes of less than around 8,000 km (e.g., satellites in low earth orbits, inclined low earth orbits, low earth circular orbits, etc.), medium earth orbit (MEO) satellites at orbital altitudes between around 8,000 km and 30,000 km (e.g., satellite in medium earth orbits), sun synchronous satellites (e.g., satellites in sun synchronous orbits), satellites in tundra orbits, satellites in Molniya orbits, satellites in polar orbits, and/or satellites in any other desired non-geosynchronous orbits around Earth. If desired, constellation 32 may include multiple sets of satellites each in a different type of orbit and/or each at different orbital altitudes. The satellites 12 of constellation 32 may be distributed in any desired number of orbital planes (e.g., having respective inclinations). In general, constellation 32 may include satellites 12 in any desired combination of orbits or orbit types.

The satellites 12 in constellation 32 may communicate with one or more UE devices 10 on Earth (e.g., UE device 10A) using one or more radio-frequency communications links (e.g., satellite-to-user equipment links). Satellites 12 may also communicate with gateways 14 on Earth using radio-frequency communications links (e.g., satellite-to-gateway links). Radio-frequency signals may be conveyed between UE devices 10 and satellites 12 and between satellites 12 and gateways 14 in IEEE bands such as the IEEE C band (4-8 GHZ), S band (2-4 GHz), L band (1-2 GHZ), X band (8-12 GHz), W band (75-110 GHZ), V band (40-75 GHZ), K band (18-27 GHZ), Kₐ band (26.5-40 GHZ), Kᵤ band (12-18 GHZ), and/or any other desired satellite communications bands. If desired, different bands may be used for the satellite-to-user equipment links than for the satellite-to-gateway links.

Communications may be performed between gateways 14 and UE devices 10 such as UE device 10A in a forward (FWD) link direction and/or in a reverse (REV or RWD) link direction. In the forward link direction (sometimes referred to simply as the forward link), wireless data is conveyed from gateway 14 to UE device 10A via constellation 32. Wireless data conveyed over the forward link is sometimes referred to herein as forward link data. Forward link data may be organized into a set, series, or stream of forward link datagrams (e.g., having header fields that contain header information, payload fields that contain a forward link data payload, etc.).

Gateway 14 may, for example, transmit forward link data to one of the satellites 12 in constellation 32 (e.g., where forward link datagrams are modulated onto one or more carriers of radio-frequency signals 28). Satellite 12 may transmit (e.g., relay, in a bent-pipe configuration) the forward link data received from gateway 14 to UE device 10A (e.g., using radio-frequency signals 26). Radio-frequency signals 28 are conveyed in an uplink direction from gateway 14 to satellite 12 and are therefore sometimes also referred to herein as uplink (UL) signals 28, forward link UL signals 28, or forward link signals 28. Radio-frequency signals 26 are conveyed in a downlink direction from satellite 12 to UE device 10A and are therefore sometimes also referred to herein as downlink (DL) signals 26, forward link DL signals 26, or forward link signals 26.

In the reverse link direction (sometimes referred to simply as the reverse link), wireless data is conveyed from UE device 10A to gateway 14 via constellation 32. Wireless data conveyed over the reverse link is sometimes referred to herein as reverse link data. Reverse link data may be organized into a set, series, or stream of reverse link datagrams (e.g., having header fields that contain header information, payload fields that contain a reverse link data payload, etc.).

UE device 10A may, for example, transmit reverse link data to one of the satellites 12 in constellation 32 (e.g., where reverse link datagrams are modulated onto one or more carriers of radio-frequency signals 24). Satellite 12 may transmit (e.g., relay, in a bent-pipe configuration) the reverse link data received from UE device 10A to a corresponding gateway 14 using radio-frequency signals 30. Radio-frequency signals 24 are conveyed in an uplink direction from UE device 10A to satellite 12 and are therefore sometimes also referred to herein as uplink (UL) signals 24, reverse link UL signals 24, or reverse link signals 24. Radio-frequency signals 30 are conveyed in a downlink direction from satellite 12 to gateway 14 and are therefore sometimes also referred to herein as downlink (DL) signals 30, reverse link DL signals 30, or reverse link signals 30.

Terrestrial network 34 may include a core network such as core network (CN) 20. CN 20 may serve as a communications interface between UE devices 10 that communicate via constellation 32 (e.g., UE device 10A) and the rest of terrestrial network 34. CN 20 may be communicatively coupled to the gateways 14 of NTN 40. Gateway 14 may forward wireless data between constellation 32 and CN 20. CN 20 may forward the wireless data to other network nodes or terminals of terrestrial network 34.

The wireless data conveyed in DL signals 26 is sometimes also referred to herein as DL data, forward link DL data, or forward link data. UL signals 28 may also convey the forward link data (e.g., forward link data that is routed by satellite 12 to UE device 10A in DL signals 26). The wireless data conveyed in UL signals 24 is sometimes also referred to herein as UL data, reverse link UL data, or reverse link data. The reverse link data may be generated and transmitted by UE device 10A. DL signals 30 may also convey the reverse link data. Forward link data may be generated by any desired network nodes or terminals of terrestrial network 34.

Forward link data and the reverse link data may include text data such as email messages, text messages, web browser data, an emergency or SOS message, a location message identifying the location of UE device 10A, or other text-based data, audio data such as voice data (e.g., for a bi-directional satellite voice call) or other audio data (e.g., streaming satellite radio data), video data (e.g., for a bi-directional satellite video call or to stream video data transmitted by gateway 14 at UE device 10A), cloud network synchronization data, data generated or used by software applications running on UE device 10A (e.g., application data), data for use in a distributed processing network, and/or any other desired data. UE device 10A may only receive forward link data, may only transmit reverse link data, or may both transmit reverse link data and receive forward link data. Each satellite 12 may communicate with UE devices 10 located within its coverage area at any given time (e.g., UE devices 10 located within cells on Earth that overlap the signal beam(s) producible by the satellite).

The satcom network service provider for communications system 38 may own, operate, control, and/or manage CN 20. CN 20 may sometimes also be referred to herein as satcom network region 20, CN region 20, satcom controller 20, satcom network 20, or satcom service provider equipment 20. CN 20 may be implemented on one or more network nodes and/or terminals of network portion 22 (e.g., one or more servers or other end hosts). In some implementations, CN 20 may be formed from a cloud computing network distributed over multiple underlying physical network nodes and/or terminals distributed across one or more geographic regions. CN 20 may therefore sometimes also be referred to herein as a CN cloud region or satcom network cloud region.

CN 20 may control and coordinate wireless communications between terminals (e.g., end hosts) of terrestrial network 34 and UE device 10A via constellation 32. For example, gateway 14 may receive reverse link data from UE device 10A via constellation 32 and may forward the reverse link data to CN 20. CN 20 may perform any desired processing operations on the reverse link data. For example, CN 20 may identify destinations for the reverse link data and may forward the reverse link data to the identified destinations.

CN 20 may also receive forward link data for transmission to UE device 10A from one or more terminals or end hosts of terrestrial network 34. CN 20 may process the forward link data to schedule the forward link data for transmission to UE device 10A via constellation 32. CN 20 may schedule the forward link data for transmission to UE device 10A by generating a forward link traffic grant for UE device 10A. CN 20 may provide the forward link data and the forward link traffic grant to gateway 14. Gateway 14 may transmit the forward link data to UE device 10A via constellation 32 according to the forward link traffic grant (e.g., according to a forward link communications schedule that implements the forward link traffic grant). CN 20 may include, be coupled to, and/or be associated with one or more content delivery networks (CDNs) that provide content for delivery to UE device 10A.

UE device 10A may convey wireless data such as message data, voice call data, video call data, application data, etc., with another UE device such as UE device 10B. Implementations in which the wireless data includes message data processed and displayed by a messaging software application are described herein as an example. The message data may include text data, icon/graphics data, image data, audio data, voice data, and/or other data. The message data as described herein may be replaced with any other desired data conveyed between UE device 10A and UE device 10B. While communications are described herein in connection with constellation 32 for the sake of illustration, NTN 40 as described herein may be replaced with any desired network (e.g., a terrestrial-based network) having lower bandwidth or capacity than terrestrial network 34 (e.g., where satellites 12 are replaced by terrestrial nodes on Earth).

When UE device 10A is on-grid, the high speed and bandwidth of terrestrial network 34 allows message data to be seamlessly conveyed between UE device 10A and UE device 10B with maximal data rates and minimal latency. However, when UE device 10A moves off-grid, the message data needs to pass through constellation 32, which greatly limits bandwidth and data rate (e.g., due to the extreme path lengths between UE device 10A and satellites 12 and between satellites 12 and gateway 14, the limited transmission resources of UE device 10A, the limited power and scheduling resources of satellites 12 in space, etc.).

The limited resources of constellation 32 can make it difficult for UE device 10A to successfully transmit and receive large amounts of message data within relatively short time periods. UE device 10A may therefore prioritize reducing the size and amount of wireless data transmitted over constellation 32 when off-grid. In some implementations, the user of UE device 10A may also face a relatively high cost per unit of data in communicating via constellation 32 (e.g., pursuant to the user's subscription to satellite services with CN 20). Care should be taken to minimize the amount of time required for UE device 10A to successfully transmit message data to UE device 10B and to successfully receive message data from UE device 10B (e.g., to minimize detriment to user experience imposed by communicating via constellation 32). Care should also be taken to ensure user privacy and to ensure that the message data is sufficiently secure in propagating through the different systems and networks of communications system 38, which are operated or managed by different entities and which can be susceptible to data breaches or attacks by unauthorized parties (e.g., man-in-the-middle attackers, etc.).

UE device 10A may be owned and/or operated by a first user. The first user may have a first user identifier (e.g., as registered with CN 20 when the first user signs up for communications service with CN 20). In implementations that are described herein as an example, a second user owns and/or operates multiple other UE devices including at least UE device 10B and UE device 10C. The UE devices of the second user (e.g., at least UE devices 10B and 10C) are collectively referred to herein as a set 18 of UE devices 10 associated with, owned by, and/or operated by the second user. Set 18 may include a single UE device 10 if desired (e.g., UE device 10B). The second user may have a second user identifier (e.g., as registered with CN 20 when the second user signs up for communications service with CN 20). The first and second user identifiers may be, for example, telephone numbers (e.g., Mobile Station International Subscriber Directory Numbers (MSISDNs)), email addresses, or user profile names. The first and second user identifiers are represented by a string of characters (e.g., alphanumeric characters, numbers, letters, symbols, etc.).

CN 20 may include a user database 27. CN 20 may store information about each of the users registered with CN 20 in user database 27. This may include, for example, user identifiers and/or information identifying different UE devices 10 belonging to a particular user identifier. If desired, some or all of the information stored in user database 27 may be anonymized, obfuscated, fuzzed, or obscured to help preserve user privacy. If desired, a single user may have multiple user identifiers that are accessed using a single UE device 10. If desired, a single user identifier may be registered to multiple different UE devices 10 and may be used by those UE devices to convey wireless data via CN 20. For example, CN 20 may store information identifying that the second user identifier of the second user is associated with each UE device 10 in set 18 (e.g., at least UE device 10B and UE device 10C).

CN 20 may, if desired, perform server-side message fan out operations in which CN 20 distributes copies of a message transmitted by UE device 10A to each UE device 10 in set 18 (e.g., maximizing the likelihood that the second user is aware of the message transmitted by UE device 10A). Examples are described herein in which UE device 10A conveys message data with one or more UE devices 10 from set 18 for the sake of illustration. In general, UE device 10 may also convey message data with UE devices that are associated with users other than the second user and/or the UE devices 10 in set 18 may communicate with UE devices that are associated users other than the first user.

When UE device 10A is on-grid, terrestrial-based communications equipment 21, CN 20, and network portion 22 may convey message data between UE device 10A and the UE device(s) 10 of set 18 without passing the message data through constellation 32. When UE device 10A goes off-grid, terrestrial-based wireless communications equipment 21 is no longer available to UE device 10A. Instead, UE device 10A may use NTN 40, CN 20, and network portion 22 to convey the message data with UE device 10B.

Messages that are transmitted by UE device 10A for receipt by the UE device(s) 10 in set 18 are sometimes also referred to herein as mobile originated (MO) messages (e.g., containing MO message data payloads). Messages that are transmitted by the UE device(s) 10 in set 18 for receipt by UE device 10A are sometimes also referred to herein as mobile terminated (MT) messages (e.g., containing MT message data payloads).

While UE device 10A is off-grid, UE device 10A may transmit an MO message to constellation 32 using UL signals 24 (for receipt by a UE device of the second user). Constellation 32 relays the MO message to gateway 14 using DL signals 30. Gateway 14 receives the MO message and forwards the MO message to CN 20. CN 20 forwards the MO message to the UE devices 10 of set 18 via network portion 22 (e.g., over the Internet). UE device 10A may encrypt the MO message in a manner such that only the UE device(s) 10 of set 18 are able to decrypt the MO message (e.g., establishing end-to-end encryption between either end of arrow 31). This prevents constellation 32, gateway 14, CN 20, network portion 22, and other unauthorized devices/attackers from being able to view the contents of the MO message. To limit bandwidth of the MO message (e.g., maximizing likelihood that constellation 32 will be able to successfully transmit the MO message to gateway 14 given the communications constraints of satellites 12), UE device 10A may also compress the MO message.

Conversely, while UE device 10A is off-grid, the second user (e.g., UE device 10B in set 18) may transmit an MT message to CN 20 via network portion 22 (for receipt by the first user and UE device 10A). To preserve message security, UE device 10B may encrypt the MT text message in a manner such that only UE device 10A is able to decrypt the MT message (e.g., establishing end-to-end encryption between either end of arrow 31). This prevents constellation 32, gateway 14, CN 20, network portion 22, and other unauthorized devices/attackers from being able to view the contents of the MT message. To limit bandwidth of the MT message (e.g., maximizing likelihood that constellation 32 will be able to successfully transmit the MT message to UE device 10A given the communications constraints of satellites 12), UE device 10B may also compress the MT message.

CN 20 may transmit the compressed and encrypted MT message to gateway 14. Gateway 14 may transmit the compressed and encrypted MT message to constellation 32 (e.g., using UL signals 28), which routes the compressed and encrypted MT text message to UE device 10A (e.g., using DL signals 26). UE device 10A may decrypt and decompress the MT message received from constellation 32 (e.g., reversing the end-to-end encryption performed by UE device 10B). If desired, a software application on UE device 10A (e.g., a messaging application) may display the MT message using a display of UE device 10A.

If desired, CN 20 may store and maintain a message queue 25 for UE device 10A and each of the other UE devices registered with CN 20 for satellite communications. Message queue 25 stores a set of incoming messages (e.g., MT messages) that are transmitted by UE devices 10 other than UE device 10A and that are addressed for receipt by UE device 10A, but that have not yet been delivered to UE device 10A over NTN 40 or the terrestrial network. Message queue 25 may store incoming messages in a corresponding order and may transmit incoming messages MS to UE device 10A according to the order. There may be an integer number Q of messages stored in message queue 25 for UE device 10. If desired, CN 20 may include, in MT messages forwarded to UE device 10A via NTN 40, information identifying the number Q of messages in message queue 25. This may serve to inform the user of UE device 10A of how many messages the CN has remaining to deliver to UE device 10A and may, if desired, allow the UE device to prompt the first user to confirm whether the first user wishes to consume additional satellite bandwidth before CN 20 delivers the remaining messages to UE device 10A. Systems and methods for operating UE device 10A, the UE device(s) 10 in set 18, and CN 20 to securely and efficiently route MT and MO messages (or any other wireless data) between UE device 10A and the UE device(s) 10 in set 18 are described in greater detail below.

A UE device 10 (e.g., UE device 10A, UE device 10B, or UE device 10C) may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

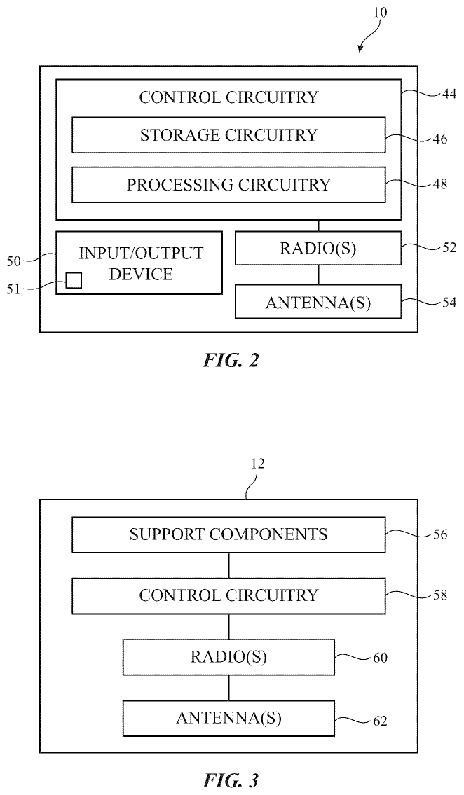

As shown in FIG. 2, UE device 10 (e.g., UE device 10A, UE device 10B, or UE device 10C of FIG. 1) may include components located on or within an electronic device housing such as housing 42. Housing 42, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 42 may be formed from dielectric or other low-conductivity material (e.g., glass, ceramic, plastic, sapphire, etc.). In other situations, housing 42 or at least some of the structures that make up housing 42 may be formed from metal elements.

UE device 10 may include control circuitry 44. Control circuitry 44 may include storage such as storage circuitry 46. Storage circuitry 46 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 46 may include storage that is integrated within UE device 10 and/or removable storage media.

Control circuitry 44 may include processing circuitry such as processing circuitry 48. Processing circuitry 48 may be used to control the operation of UE device 10. Processing circuitry 48 may include on one or more processors such as microprocessors, microcontrollers, digital signal processors, host processors, baseband processor integrated circuits, application specific integrated circuits, central processing units (CPUs), graphics processing units (GPUs), etc. Control circuitry 44 may be configured to perform operations in device 10 using hardware (e.g., dedicated hardware or circuitry), firmware, and/or software. Software code for performing operations on UE device 10 may be stored on storage circuitry 46 (e.g., storage circuitry 46 may include non-transitory (tangible) computer readable storage media that stores the software code). The software code may sometimes be referred to as program instructions, software, data, instructions, or code. Software code stored on storage circuitry 46 may be executed by processing circuitry 48.

Control circuitry 44 may be used to run software on UE device 10 such as satellite navigation applications, internet browsing applications, voice-over-internet-protocol (VOIP) telephone call applications, email applications, media playback applications, operating system functions, etc. To support interactions with external equipment, control circuitry 44 may be used in implementing communications protocols. Communications protocols that may be implemented using control circuitry 44 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), satellite communications protocols, and/or any other desired communications protocols. Each communications protocol may be associated with a corresponding radio access technology (RAT) that specifies the physical connection methodology used in implementing the protocol.

UE device 10 may store satellite information associated with one or more of the satellites 12 in satellite constellation 32 on storage circuitry 46. The satellite information, sometimes referred to herein as ephemeris data or ephemeris information, may include a satellite almanac identifying the orbital parameters/position (e.g., orbit information, elevation information, altitude information, inclination information, eccentricity information, orbital period information, trajectory information, right ascension information, declination information, ground track information, etc.) and/or the velocity of satellites 12 (e.g., relative to the surface of Earth). This information may include a two-line element (TLE), for example. The TLE may identify or include information about the orbital motion of one or more of the satellites 12 in satellite constellation 32 (e.g., satellite epoch, first and/or second derivatives of motion, drag terms, etc.). The TLE may be in the format of a text file having two lines or columns that include the set of elements forming the TLE, for example. Control circuitry 44 may use the ephemeris data to calculate, predict, or identify the location of satellites 12 at a given point in time.

UE device 10 may also include wireless circuitry to support wireless communications. The wireless circuitry may include one or more antennas 54 and one or more radios 52. Each radio 52 may include circuitry that operates on signals at baseband frequencies (e.g., baseband processing circuitry, one or more baseband processors, etc.), signal generator circuitry, modulation/demodulation circuitry (e.g., one or more modems), radio-frequency transceiver circuitry (e.g., radio-frequency transmitter circuitry, radio-frequency receiver circuitry, mixer circuitry for downconverting radio-frequency signals to baseband frequencies or intermediate frequencies between radio and baseband frequencies and/or for upconverting signals at baseband or intermediate frequencies to radio-frequencies, etc.), amplifier circuitry (e.g., one or more power amplifiers and/or one or more low-noise amplifiers (LNAs)), analog-to-digital converter (ADC) circuitry, digital-to-analog converter (DAC) circuitry, control paths, power supply paths, signal paths (e.g., radio-frequency transmission lines, intermediate frequency transmission lines, baseband signal lines, etc.), switching circuitry, filter circuitry, and/or any other circuitry for transmitting and/or receiving radio-frequency signals using antenna(s) 54. The components of each radio 52 may be mounted onto a respective substrate or integrated into a respective integrated circuit, chip, package, or system-on-chip (SOC). If desired, the components of multiple radios 52 may share a single substrate, integrated circuit, chip, package, or SOC.

Antenna(s) 54 may be formed using any desired antenna structures. For example, antenna(s) 54 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, one or more antennas 54 may include antenna resonating elements formed from conductive portions of housing 42 (e.g., peripheral conductive housing structures extending around a periphery of a display on UE device 10). Filter circuitry, switching circuitry, impedance matching circuitry, and/or other antenna tuning components may be adjusted to adjust the frequency response and wireless performance of antenna(s) 54 over time. If desired, multiple antennas 54 may be implemented as a phased array antenna (e.g., where each antenna forms a radiator or antenna element of the phased array antenna, which is sometimes also referred to as a phased antenna array). In these scenarios, the phased array antenna may convey radio-frequency signals within a signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time.

Transceiver circuitry in radios 52 may convey radio-frequency signals using one or more antennas 54 (e.g., antenna(s) 54 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antenna(s) 54 may transmit the radio-frequency signals by radiating the radio-frequency signals into free space (or to free space through intervening device structures such as a dielectric cover layer). Antenna(s) 54 may additionally or alternatively receive the radio-frequency signals from free space (e.g., through intervening devices structures such as a dielectric cover layer). The transmission and reception of radio-frequency signals by antenna(s) 54 each involve the excitation or resonance of antenna currents on an antenna resonating element in the antenna by the radio-frequency signals within the frequency band(s) of operation of the antenna.

Each radio 52 may be coupled to one or more antennas 54 over one or more radio-frequency transmission lines. The radio-frequency transmission lines may include coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines may be integrated into rigid and/or flexible printed circuit boards if desired. One or more of the radio-frequency lines may be shared between radios 52 if desired. Radio-frequency front end (RFFE) modules may be interposed on one or more of the radio-frequency transmission lines. The radio-frequency front end modules may include substrates, integrated circuits, chips, or packages that are separate from radios 52 and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission lines.

Radios 52 may use antenna(s) 54 to transmit and/or receive radio-frequency signals within different frequency bands at radio frequencies (sometimes referred to herein as communications bands or simply as a “bands”). The frequency bands handled by radios 52 may include satellite communications bands (e.g., the C band, S band, L band, X band, W band, V band, K band, Kₐ band, Kᵤ band, etc.), wireless local area network (WLAN) frequency bands (e.g., Wi-Fi® (IEEE 802.11) or other WLAN communications bands) such as a 2.4 GHZ WLAN band (e.g., from 2400 to 2480 MHZ), a 5 GHz WLAN band (e.g., from 5180 to 5825 MHZ), a Wi-Fi® 6E band (e.g., from 5925-7125 MHZ), and/or other Wi-Fi® bands (e.g., from 1875-5160 MHz), wireless personal area network (WPAN) frequency bands such as the 2.4 GHZ

Bluetooth® band or other WPAN communications bands, cellular telephone frequency bands (e.g., bands from about 600 MHz to about 5 GHZ, 3G bands, 4G LTE bands, 5G New Radio Frequency Range 1 (FR1) bands below 10 GHZ, 5G New Radio Frequency Range 2 (FR2) bands between 20 and 60 GHZ, 6G bands such as sub-THz bands between around 100 GHZ and around 10 THz, etc.), other centimeter or millimeter wave frequency bands between 10-300 GHz, near-field communications (NFC) frequency bands (e.g., at 13.56 MHZ), satellite navigation frequency bands (e.g., a GPS band from 1565 to 1610 MHZ, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Although control circuitry 44 is shown separately from radios 52 in the example of FIG. 2 for the sake of clarity, radios 52 may include processing circuitry that forms a part of processing circuitry 48 and/or storage circuitry that forms a part of storage circuitry 46 of control circuitry 44 (e.g., portions of control circuitry 44 may be implemented on radios 52). As an example, control circuitry 44 may include baseband circuitry or other control components that form a part of radios 52. The baseband circuitry may, for example, access a communication protocol stack on control circuitry 44 (e.g., storage circuitry 46) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

UE device 10 may include input-output devices 50. Input-output devices 50 may be used to allow data to be supplied to UE device 10 and to allow data to be provided from UE device 10 to external devices. Input-output devices 50 may include user interface devices, data port devices, and other input-output components. For example, input-output devices 50 may include touch sensors, displays such as display 51 (e.g., a touch-sensitive and/or force-sensitive display), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, orientation sensors, inertial measurement units, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 50 may be peripherals that are coupled to a main processing unit or other portion of device 10 via a wired or wireless link). UE device 10 may be owned and/or operated by an end user.

If desired, UE device 10 may include one or more subscriber identity modules (SIMs) (not shown in FIG. 2 for the sake of clarity). A SIM on UE device 10 may be associated with (e.g., owned or managed by) a corresponding carrier network. Radio 52 may use a SIM to access the associated carrier network (e.g., to use the carrier network to route wireless data for the UE device). A SIM may include a SIM card, may be integrated into UE device 10 (e.g., may be an eSIM), or may be a removable SIM card. If desired, UE device 10 may include multiple SIMs for supporting multi-SIM communications with multiple different carrier networks. A SIM on UE device 10 may identify a corresponding subscription to the wireless services of the corresponding carrier network and may include, identify, or otherwise be associated with a corresponding SIM credential. The user who holds the subscription (e.g., the user of UE device 10) is sometimes referred to as a subscriber of the corresponding carrier network.

Each subscription to a carrier network may have a corresponding Mobile Station International Subscriber Directory Number (MSISDN) (e.g., representing a globally unique telephone number associated with the subscription). A SIM on UE device 10 may therefore include information identifying its corresponding MSISDN (e.g., the MSISDN of UE device 10). The corresponding carrier network may include a subscription manager that stores and/or identifies all subscribers, subscriptions, and MSISDNs of the carrier network. The carrier network may use its subscription manager to verify the MSISDN of UE device 10 (e.g., using a challenge and response scheme) before providing UE device 10 with cellular telephone service (e.g., text message routing service). The MSISDN of the SIM may be unique to UE device 10 or may be shared by the same subscriber between multiple UE devices if desired.

A gateway 14 (FIG. 1) may include one or more radios that include one or more components similar to radio(s) 52, one or more antennas, one or more input/output devices, and control circuitry that includes one or more components similar to control circuitry 44. Unlike UE devices 10, gateway 14 is stationary and remains at a fixed location on Earth. Gateways 14 are not owned or operated by end users of UE devices 10. Gateway 14 may include one or more electronic devices. The electronic device(s) of a gateway 14 may be enclosed within a housing, enclosure, building, etc.

FIG. 3 is a diagram of an illustrative satellite 12 in communications system 38. As shown in FIG. 3, satellite 12 may include satellite support components 56. Support components 56 may include batteries, solar panels, sensors (e.g., accelerometers, gyroscopes, temperature sensors, light sensors, etc.), guidance systems, propulsion systems, and/or any other desired components associated with supporting satellite 12 in orbit above Earth.

Satellite 12 may include control circuitry 58. Control circuitry 58 may be used in controlling the operations of satellite 12. Control circuitry 58 may include processing circuitry such as processing circuitry 48 of FIG. 2 and may include storage circuitry such as storage circuitry 46 of FIG. 2. Control circuitry 58 may also control support components 56 to adjust the trajectory or position of satellite 12 in space.

Satellite 12 may include antennas 62 and one or more radios 60. Radios 60 may use antennas 62 to transmit DL signals 26 and DL signals 30 and to receive UL signals 24 and UL signals 28 of FIG. 1 (e.g., in one or more satellite communications bands). Radios 60 may include transceivers, modems, integrated circuit chips, application specific integrated circuits, filters, switches, up-converter circuitry, down-converter circuitry, analog-to-digital converter circuitry, digital-to-analog converter circuitry, amplifier circuitry (e.g., multiport amplifiers), beam steering circuitry, etc.

Antennas 62 may include any desired antenna structures (e.g., patch antenna structures, dipole antenna structures, monopole antenna structures, waveguide antenna structures, Yagi antenna structures, inverted-F antenna structures, cavity-backed antenna structures, combinations of these, etc.). In some implementations, antennas 62 may include one or more phased array antennas. Each phased array antenna may include beam forming circuitry having a phase and magnitude controller coupled to each antenna element in the phased array antenna. The phase and magnitude controllers may provide a desired phase and magnitude to the radio-frequency signals conveyed over the corresponding antenna element. The phases and magnitudes of each antenna element may be adjusted so that the radio-frequency signals conveyed by each of the antenna elements constructively and destructively interfere to produce a radio-frequency signal beam (e.g., a spot beam) in a desired pointing direction (e.g., an angular direction towards Earth at which the radio-frequency signal beam exhibits peak gain). Radio-frequency lenses may also be used to help guide the radio-frequency signal beam in a desired pointing direction. Each radio-frequency signal beam also exhibits a corresponding beam width. This allows each radio-frequency signal beam to cover a corresponding area on Earth (e.g., a region on Earth overlapping the radio-frequency signal beam such that the radio-frequency signal beam exhibits a power greater than a minimum threshold value within that region/cell). Satellite 12 may convey radio-frequency signals over multiple concurrently-active signal beams if desired. If desired, satellite 12 may offload some or all of its beam forming operations to gateway 14. The signal beams may sometimes be referred to herein simply as beams.

If desired, radios 60 and antennas 62 may support communications using multiple polarizations. For example, radios 60 and antennas 62 may transmit and receive radio-frequency signals with a first polarization (e.g., a left-hand circular polarization (LHCP)) and may transmit and receive radio-frequency signals with a second polarization (e.g., a right-hand circular polarization (RHCP)). Antennas 62 may be able to produce a set of different signal beams at different beam pointing angles (e.g., where each beam overlaps a respective cell on Earth). The set of signal beams may include a first subset of signal beams that convey LHCP signals (e.g., LHCP signal beams) and a second subset of signal beams that convey RHCP signals (e.g., RHCP signal beams). The LHCP and RHCP signal beams may, for example, be produced using respective multiport power amplifiers (MPAs) on satellite 12. This is illustrative and, in general, satellite 12 may produce any desired number of signal beams having any desired polarizations.

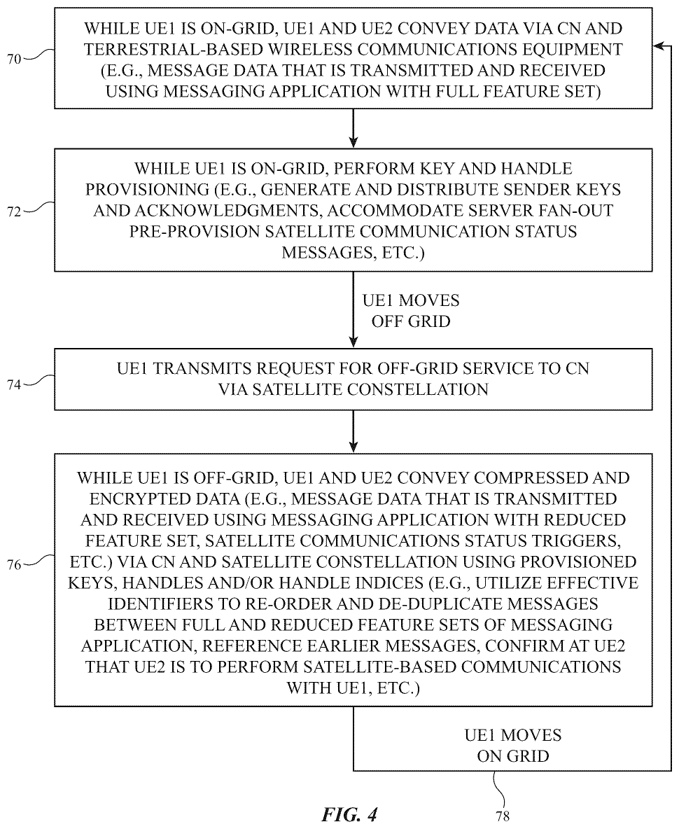

FIG. 4 is a flow chart of operations that may be performed by communications system 38 to convey wireless data (e.g., message data) between the UE device(s) 10 of set 18 and a UE device 10A that changes between being on-grid and off-grid. The operations of FIG. 4 may, for example, be performed after UE device 10A has already registered with and/or subscribed to satellite-based communications offered by CN 20 via NTN 40 (e.g., messaging via satellite service). In this example, the second user associated with set 18 is already known to the first user associated with UE device 10A. UE device 10A may store information identifying the second user (e.g., the second user identifier associated with the second user). The second user and/or the second user identifier may, for example, be stored in a contacts list on UE device 10A. The contacts list may be accessed, displayed, maintained, and/or updated by the messaging application, operating system, and/or a contacts application running on UE device 10A.

At operation 70, while UE device 10A is on-grid, UE device 10A (UE1) and UE device 10B (UE2) may convey wireless data via CN 20, terrestrial-based communications equipment 21, and network portion 22 (e.g., without passing the wireless data through NTN 40). UE devices 10A and 10B may, for example, each execute a messaging software application that receives user input identifying one or more messages, that transmits/receives the one or more messages, that processes the one or more messages, and/or that displays the one or more messages on displays of the UE devices. The messaging application may convey the messages using a full feature set of the messaging application. When the full feature set of the messaging application is available, the messaging application may use a first protocol to generate, transmit, and receive the messages. The terrestrial-based communications equipment exhibits sufficient bandwidth to convey messages that support the full feature set of the messaging application with maximal data rate, minimal latency, minimal data loss, and minimal detriment to user experience. Operation 72 may be performed prior to and/or concurrent with operation 70 if desired.

At operation 72, while UE device 10A is still on-grid, UE device 10A and CN 20 may perform cryptographic key provisioning and user handle provisioning between UE device 10A and UE devices 10 that are known to UE device 10A (e.g., UE devices associated with users in the contacts list on UE device 10A). For example, UE device 10A and CN 20 may perform cryptographic key provisioning and user handle provisioning with the UE device(s) 10 of set 18 (e.g., at least UE device 10B of FIG. 1).

Cryptographic key provisioning may involve the generation of one or more cryptographic sender keys by UE device 10A and the distribution, via CN 20, of the sender key(s) to UE devices 10 associated with users in the contacts list on UE device 10A. Cryptographic key provisioning may also involve the receipt, via CN 20, of sender keys by UE device 10A from UE devices 10 associated with users in the contacts list on UE device 10A. User handle provisioning may involve the generation of respective handles for each user identifier in the contacts list on UE device 10A. Each handle may uniquely identify a corresponding user from the contacts list but consumes substantially less data than the corresponding user identifier. If desired, UE device 10A may perform handle provisioning while off-grid. If desired, the key and handle provisioning may accommodate server fan-out, in which CN 20 distributes one or more sender keys from UE device 10A to multiple UE devices 10 owned by the same user (e.g., the UE device(s) 10 in set 18). If desired, UE device 10A may also provision satellite communications (satcom) status messages, transmitting as much of the satcom status messages to CN 20 for storage while UE device 10A is on-grid and then releasing the status messages only after UE device 10A has moved off-grid.

The provisioning performed at operation 72 (sometimes also referred to herein as pre-provisioning) may serve to offload as much data onto CN 20 as possible for later use when UE device 10A is off-grid, leveraging the high bandwidth of terrestrial-based communications equipment 21 and helping to minimize the amount of data and bandwidth required for UE device 10A to communicate via satellite constellation 32 while off-grid. This may serve to minimize latency and disruption to user experience in using constellation 32 to convey messages for UE device 10A. Further detail of key provisioning, handle provisioning, server fan-out, and satcom status message pre-provisioning are described in greater detail below.

If/when UE device 10A goes off-grid, processing may proceed to operation 74. At operation 74 (e.g., responsive to UE device 10A moving off-grid), UE device 10A may transmit a request for off-grid service (e.g., a service request or initialization message) to CN 20 via constellation 32. CN 20 may receive the request for off-grid service. If desired, responsive to receipt of the request for off-grid service, CN 20 may check user database 27 to determine whether UE device 10A has an active subscription to satellite communications with CN 20.

At operation 76, while UE device 10A is off-grid, UE device 10A may convey wireless data (e.g., MT messages and/or MO messages) with the UE device(s) 10 in set 18 (e.g., at least UE device 10B) via constellation 32, CN 20, and network portion 22. UE device 10A, the UE device(s) 10 of set 18, and/or CN 20 may use the cryptographic keys, handles, and/or satcom status messages provisioned while UE device 10A was off-grid (e.g., at operation 72) to convey messages between UE device 10A and the UE device(s) 10 of set 18 in a secure and resource-efficient manner. Messages conveyed between UE device 10A and the UE device(s) 10 in set 18 may, for example, be end-to-end encrypted (e.g., using the provisioned sender keys) as shown by arrow 31 of FIG. 1.

If desired, the messages may be transmitted and received by the messaging application on UE device 10A and UE device 10B using a reduced feature set. The reduced feature set may include some but not all of the features from the full feature set of the messaging application. When the reduced feature set of the messaging application is used, the messaging application may use a second protocol that is different from the first protocol (e.g., a modified version of the first protocol) to generate, transmit, and receive the messages. The reduced feature set and the second protocol may cause the messages to consume as little data as possible (e.g., as few bits as possible). This serves to minimize the amount of data conveyed over constellation 32, which may minimize latency, minimize data loss, minimize detriment to user experience, and maximize the likelihood that UE device 10A will be able to successfully transmit and/or receive messages via constellation 32 given the constraints of space-based communication.

Processing may loop back to operation 72 if/when UE device 10A goes back on-grid. Once back on-grid, UE device 10 may continue to convey messages with the UE device(s) 10 of set 18 but at higher data rates, with greater bandwidth, and with lower latency than conveying the wireless data via constellation 32. If desired, the messages conveyed after UE device 10A has moved back on-grid may include one or more MT messages from message queue 25 (FIG. 1) that constellation 32 was otherwise unable to deliver to UE device 10A or gateway 14 while UE device 10A was off-grid. If desired, UE device 10A may re-provision keys, handles, and/or satcom status messages every time UE device 10A goes back on-grid and/or periodically (e.g., operation 72 may be performed every 24 hours, every 30 days, every 60 days, every 12 hours, etc., while UE device 10A is on-grid). This may serve to maximize the security of wireless communications over time.

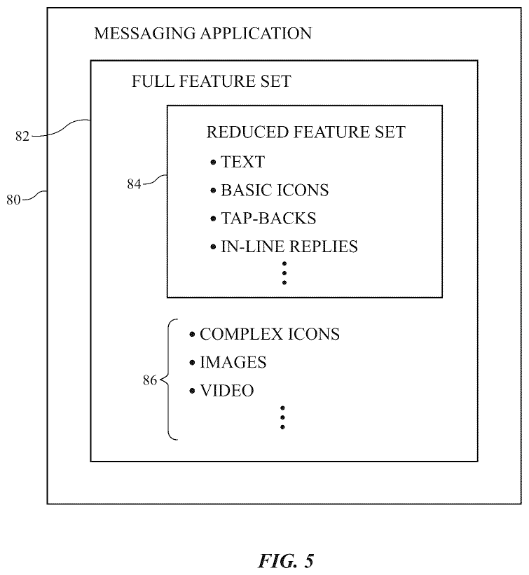

FIG. 5 is a diagram of an exemplary messaging application 80 that may be stored on and executed by UE device 10A and the UE device(s) 10 in set 18 (e.g., UE device 10B) to convey messages (e.g., while processing operations 70 and 76 of FIG. 4). As shown in FIG. 5, messaging application 80 may have a full feature set 82 of messaging features used in generating, transmitting, and receiving messages. Full feature set 82 (sometimes also referred to herein as full, high-data, or complex messaging) may include a reduced feature set 84 and additional features 86 not included in reduced feature set 84.

Reduced feature set 84 (sometimes also referred to herein as light, low-data, lite, or simplified messaging) may include the capability of generating, transmitting, and receiving strings of text characters (e.g., alphanumeric characters and text-based symbols) and basic icons (e.g., a first set of emojis). Reduced feature set 84 may also include support for tap-back messages, in which the messaging application receives a user input that references a previously transmitted or received message and a corresponding interaction or action to be performed on the previously transmitted or received message (e.g., adding an icon to the previously transmitted or received message, which is then displayed by the messaging application and transmitted to a different UE device for display on that device). Reduced feature set 84 may further include support for in-line reply messages, in which a transmitted or received message references a previously transmitted or received message and serves as an in-line reply for the previously transmitted or received message. The messaging application may display the in-line reply by including some or all of the transmitted or received message adjacent to or in-line with the referenced previously transmitted or received message.

Additional features 86 may include features that consume more data and/or bandwidth than reduced feature set 84. Additional features 86 may include, for example, the ability to transmit and/or receive complex icons (e.g., a second set of emojis), stickers, images (e.g., in-line images and/or image attachments), animated images (e.g., GIFs or other animated files), and/or videos (e.g., in-line videos and/or video attachments). If desired, additional features 86 may include additional or enhanced security features. Messaging application 80 may use the first protocol to generate, transmit, and receive messages when using full feature set 82. Messaging application 80 may use the second protocol to generate, transmit, and receive messages when using reduced feature set 84. The second protocol may, for example, be a modified or pared-down version of the first protocol. Messages conveyed using the first protocol and full feature set 82 may consume more data and bandwidth than messages conveyed using the second protocol and reduced feature set 84. Conveying messages using reduced feature set 84 while off-grid may minimize latency, data loss, and detriment to user experience when messaging application 80 is used-off grid to convey messages via constellation 32. The example of FIG. 5 is illustrative and non-limiting. In general, full feature set 82 may include any desired features or capabilities and reduced feature set 84 may include any desired subset of features or capabilities from full feature set 82.

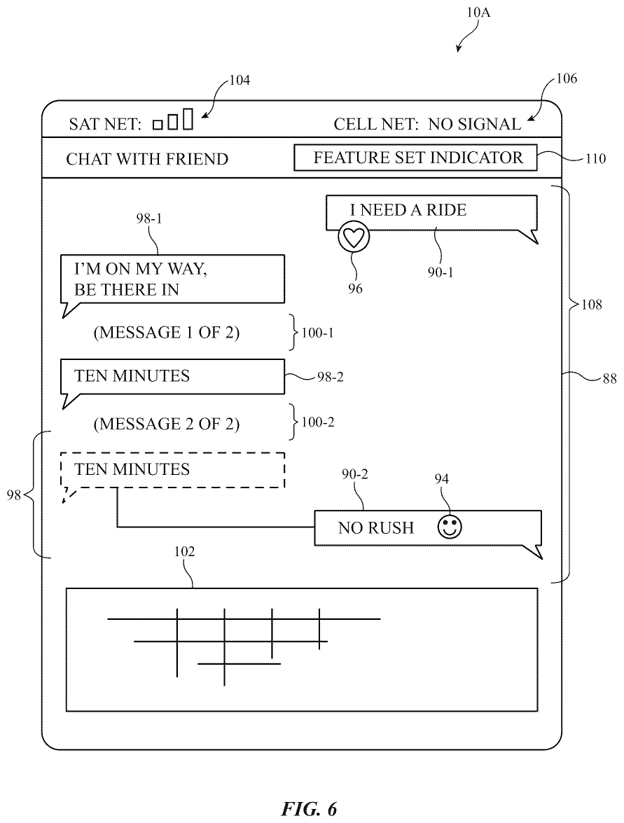

FIG. 6 shows an example of a graphical user interface (GUI) 88 that may be displayed on display 51 (FIG. 3) of UE device 10A while communicating with UE device 10B when UE device 10A is off-grid (e.g., while UE device 10A performs operation 76 of FIG. 4). As shown in FIG. 6, messaging application 80 and/or the operating system of UE device 10A may display GUI 88 on display 51. GUI 88 may display messages conveyed by messaging application 80 (FIG. 5) between UE device 10A and UE device 10B within a text field such as text field 108. GUI 88 may also display a graphical keyboard 102 that receives user input such as keystrokes that type out messages 90. If desired, keyboard 102 may be omitted from GUI 88 and the user may use a physical keyboard or any other desired user input device or accessory to enter the text.

If desired, GUI 88 may also display a first graphical connectivity indicator 106 associated with the cellular carrier network of UE device 10A and/or a second graphical connectivity indicator 104 associated with NTN 40. Indicator 106 may, for example, identify the signal strength, connectivity level, and/or wireless performance metric data associated with wireless communications using the cellular carrier network. Indicator 104 may, for example, identify the signal strength, connectivity level, and/or wireless performance metric data associated with wireless communications using constellation 32. As shown in the example of FIG. 6, the cellular carrier network is unavailable (e.g., “NO SIGNAL”) because UE device 10A is off-grid. However, NTN 40 remains available to UE device 10A while UE device 10A is off-grid.

Messaging application 80 may transmit messages 90 as MO messages using reduced feature set 84 (FIG. 5). GUI 88 may display transmitted messages 90. UE device 10A may receive messages 98 transmitted by UE device 10B as MT messages using reduced feature set 84. GUI 88 may display received messages 98 (e.g., opposite transmitted messages 90). GUI 88 may also display status indicators 100 based on received information about the message queue 25 for UE device 10A maintained at CN 20. CN 20 may transmit information about message queue 25 along with each message 98 routed to UE device 10A via constellation 32.

In the example of FIG. 6, UE device 10A receives a first message 98-1 and then a second message 98-2 from UE device 10B via CN 20 and constellation 32. Messages 98-1 and 98-2 are end-to-end encrypted between UE devices 10A and 10B. The messaging application 80 on UE device 10A may decompress, decrypt, and display message 98-1 on GUI 88. UE device 10A may receive status information from CN 20 indicating that message 98-1 is the first of two messages in message queue 25 and destined for UE device 10A from UE device 10B. Messaging application 80 may display status indicator 100-1 on GUI 88 (e.g., below or near message 98-1). This may serve to inform the first user of UE device 10A that message queue 25 still contains another message 98-2 for receipt at UE device 10A.

After UE device 10A receives message 98-2, messaging application 80 may decompress, decrypt, and display message 98-2 on GUI 88. UE device 10A may receive status information from CN 20 indicating that message 98-2 is the second of two messages destined for UE device 10A from UE device 10B. Messaging application 80 may display status indicator 100-2 on GUI 88 (e.g., below or near message 98-2). This may serve to inform the first user of UE device 10A that message queue 25 contains no further messages 98-2 for receipt at UE device 10A from UE device 10B.

The example of FIG. 6 illustrates some of the messaging features supported by reduce feature set 84 (FIG. 5) in conveying messages 90 and 98 via constellation 32. As shown in FIG. 6, GUI 88 may display a feature set indicator 110 (e.g., an icon, text, alert, notification, banner, bubble, badge, etc.). While off-grid, feature set indicator 110 may include information indicating or identifying that messaging application 80 is currently transmitting and receiving messages using the second protocol and using reduced feature set 84. Feature set indicator 110 may include information identifying that messaging application 80 is currently conveying messages using the first protocol and using full feature set 84 when on-grid.

If desired, reduced feature set 84 may support tap-back actions, operations, interactions, or inputs. For example, the second user of UE device 10B may perform a tap-back on message 90-1 after receipt of message 90-1 by UE device 10A. The tap-back may reference message 90-1. UE device 10B may use the second protocol to transmit a tap-back message to UE device 10A via CN 20 and constellation 32. The tap-back message may identify the tap-back, the corresponding user action, interaction, or input, and the message that is referenced by the tap-back (e.g., message 90-1). The tap-back message may cause the messaging application 80 on UE device 10A to display a corresponding graphical element 96 (e.g., an icon, emoji, shape, etc.) on GUI 88 at, overlapping, or adjacent the referenced message 90-1 identified by the tap-back message and already displayed on GUI 88. Similarly, the messaging application 80 on UE device 10A may transmit a tap-back message to UE device 10B when UE device 10A receives a user input identifying a tap-back and referencing an earlier transmitted or received message. GUI 88 may also display a graphical element such as graphical element 96 associated with the user input (e.g., at, overlapping, or on the referenced message).

If desired, reduced feature set 84 may support in-line replies. For example, UE device 10A may receive a user input referencing an earlier transmitted or received message and including a new message in response to the earlier transmitted or received message (sometimes referred to herein as the responsive message of the in-line reply). GUI 88 may display both the referenced earlier message and the responsive message as an in-line reply 98. In the example of FIG. 6, for instance, UE device 10A receives a user input that references received message 98-2 and that identifies a responsive message to be transmitted to UE device 10B (e.g., message 90-2). GUI 88 may display a corresponding in-line reply 98 that includes both the referenced message 98-2 and the responsive message 90-2 (e.g., overlapping each other, adjacent to each other, and/or with a graphical element that visually connects or ties the referenced message to the responsive message in the in-line reply). UE device 10A may use the second protocol to transmit an in-line reply message to UE device 10B via constellation 32 and CN 20. UE device 10B may display in-line reply 98 on its own GUI. If desired, reduced feature set 84 may also support basic icons such as icon 94 (e.g., an emoji or similar small graphical element). Icons such as icon 94 may be included in transmitted messages 90 and/or in received messages 98.

Messaging application 80 may convey messages via constellation 32 and CN 20 that include one or more of the features from reduced feature set 84 without consuming excessive bandwidth or data. When on-grid, messaging application 80 may include additional features 86 in transmitted and/or received messages (e.g., images, videos, etc.). Including some but not all of the features from full feature set 82 in reduced feature set 84 may serve to minimize noticeable changes to the user interface of messaging application 80 while UE device 10A is off-grid while also minimizing bandwidth, latency, data loss, and disruption to user experience in conveying messages with UE device 10B. The example of FIG. 6 is illustrative and non-limiting. In general, GUI 88 may display any desired information in any desired manner.

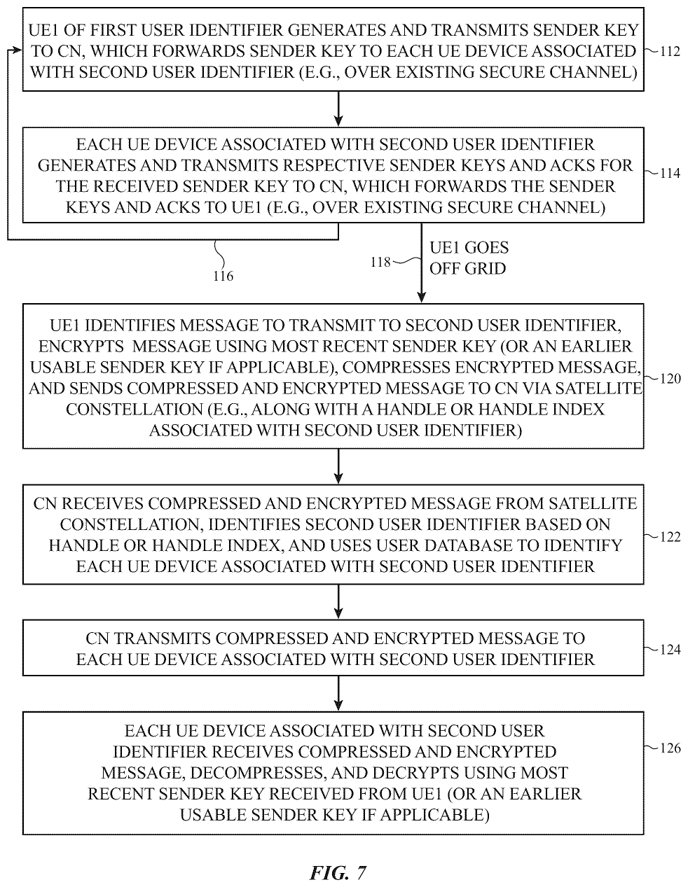

FIG. 7 is a flow chart of illustrative operations involved in provisioning and utilizing cryptographic keys to transmit messages (e.g., MO messages) from UE device 10A to the UE devices 10 in set 18 (e.g., utilizing server fan-out by CN 20). Operations 112-114 of FIG. 7 may be performed while processing operation 72 of FIG. 4 (e.g., while UE device 10A is on-grid). Operations 120-126 of FIG. 7 may be performed while processing operation 76 of FIG. 4 (e.g., while UE device 10A is off-grid).

At operation 112, UE device 10A (UE1) may generate a sender key associated with UE device 10A. The sender key may be, for example, a symmetric key unique to UE device 10A. UE device 10A may transmit the sender key to each UE device 10 in set 18 over an existing (already-established) secure channel through CN 20 on the terrestrial network. UE device 10A may, for example, transmit the sender key to CN 20 along with information identifying the second user associated with set 18 (e.g., a destination or receiver address field that includes the second user identifier associated with the second user, a handle corresponding to the second user identifier, or a handle index associated with the handle). CN 20 may then forward or route the sender key to each UE device 10 associated with the second user and set 18. If desired, CN 20 may forward the sender key to one or more UE devices 10 associated with each user identifier in the contact list of UE device 10A.

At operation 114, each UE device 10 in set 18 may transmit, over the terrestrial network and the existing secure channel through CN 20, a respective acknowledgement (ACK) message to the sender key received from UE device 10A. UE device 10A may receive the ACK messages and may use the stored ACK messages to track the version of its sender key successfully received by each UE device. Each UE device 10 in set 18 may also transmit, over the terrestrial network and the existing secure channel through CN 20, a respective sender key to UE device 10A that is unique to the UE devices 10 in set 18. The generation and transmission of sender keys between UE device 10A and the UE devices 10 in set 18 via CN 20 is sometimes referred to herein as key provisioning.

While UE device 10A remains on-grid, processing may loop back to operation 112 via path 116 to re-provision sender keys (e.g., periodically, every 24 hours, every 30 hours, every 60 hours, every 5 days, every 7 days, every 30 days, every 40 days, every 60 days, whenever UE device 10A powers on, whenever a sender key is set to expire, etc.). In this way, the UE devices may periodically re-generate, refresh, and/or rotate the distributed sender keys, which helps to maximize communications security over time. Processing may proceed from operation 114 to operation 120 via path 118 if/when UE device 10A goes off-grid.

At operation 120 (e.g., responsive to UE device 10A going off-grid and after requesting service at operation 74 of FIG. 4), UE device 10A may identify a message to transmit to the second user identifier (e.g., an MO message for transmission by messaging application 80). UE device 10A may, for example, receive a user input or an application call identifying that messaging application 80 is to transmit a particular message (e.g., message 90 of FIG. 6) to the second user associated with the second user identifier.

The messaging application 80 on UE device 10A may encrypt the identified message using one of the sender keys transmitted to CN 20 (e.g., during an iteration of operation 112). Messaging application 80 may compress the encrypted message to produce a compressed and encrypted message. Alternatively, messaging application 80 may compress the message prior to encryption. UE device 10A may transmit the compressed and encrypted message to CN 20 via constellation 32.

UE device 10A may transmit a handle or handle index associated with the second user identifier along with the compressed and encrypted message to CN 20 (e.g., in an unencrypted receiver or destination address field of the compressed and encrypted message or in a field of the compressed and encrypted message that is encrypted using another key known to CN 20). The handle is shorter than the second user identifier and the handle index is shorter than the handle. The handle or handle index may serve to identify, to CN 20, that the compressed and encrypted message is intended for receipt by the second user using as little data as possible, which conserves bandwidth and minimizes latency. The messaging application 80 on UE device 10A may display the transmitted messages using GUI 88 (FIG. 6).

At operation 122, CN 20 may receive the compressed and encrypted message and the handle or handle index from UE device 10A via constellation 32. CN 20 may identify (e.g., compute, deduce, recover, expand, calculate, etc.) the second user identifier based on the handle or handle index. CN 20 may identify each UE device 10 that is associated with the second user handle (e.g., may identify a list of each UE device 10 in set 18 based on data in user database 27 of FIG. 1).

At operation 124, CN 20 may forward the compressed and encrypted message to each UE device 10 in set 18 over network portion 22 (e.g., at least UE device 10B and UE device 10C of FIG. 1). Put differently, CN 20 may fan out copies of the compressed and encrypted message across each UE device 10 associated with the second user identifier. CN 20 does not have knowledge of the sender key of UE device 10A and is unable to decrypt or view the payload of the compressed and encrypted message.

At operation 126, each UE device 10 in set 18 may receive the compressed and encrypted message. Each UE device 10 in set 18 may decompress the compressed and encrypted message to recover the encrypted message. Each UE device 10 in set 18 possesses a sender key of UE device 10A (as provisioned at operation 112) and may use that sender key to decrypt the encrypted message, recovering the payload of the message. The messaging application 80 on each UE device 10 in set 18 may display the recovered payload of the message if desired.

In some situations, the sender key of UE device 10A that is used by UE device 10A to encrypt the transmitted message (e.g., at operation 120) and that is used by the UE devices 10 in set 18 to decrypt the transmitted message (e.g., at operation 126) is the most-recent sender key transmitted by UE device 10A while on-grid (e.g., during a most-recent iteration of operation 112). This is illustrative and non-limiting. In some situations, the sender key used to encrypt and decrypt the message may be a previous version of the sender key (e.g., an earlier usable sender key) that was transmitted during an iteration of operation 112 prior to the most recent iteration of operation 112.

For example, UE device 10A may transmit a first sender key to UE device 10B at a first time (e.g., during a first iteration of operation 112) and may transmit a second sender key to UE device 10B at a second time subsequent to the first time (e.g., during a second iteration of operation 112). In situations where UE device 10B goes off-grid after receiving the first sender key but prior to UE device 10A transmitting the second sender key, UE device 10A may have no knowledge that UE device 10B has moved off-grid. If/when UE device 10B then becomes available to UE device 10A for off-grid communications via constellation 32, UE device 10A would need to encrypt its transmitted messages using the first sender key rather than the second sender key for UE device 10B to successfully be able to decrypt the messages (e.g., because UE device 10B has the first sender key but not the more recent second sender key).

To mitigate this issue, UE device 10A may track the acknowledgements received from the UE devices 10 in set 18 responsive to the sender keys transmitted by UE device 10A while iterating over operation 112. In this example, UE device 10A may receive an ACK message from UE device 10B to the first sender key but does not receive an ACK message from UE device 10B to the second sender key (e.g., because UE device 10B went off-grid prior to receiving the second sender key). When communicating with UE device 10B after UE device 10B has gone off-grid, UE device 10A may identify the most recent sender key for which UE device 10A has received an ACK message from UE device 10B (e.g., the first sender key but not the second sender key). UE device 10A may then use that identified sender key to encrypt the message transmitted to UE device 10B via constellation 32 rather than using a later or most-recent sender key (e.g., the second sender key). This serves to ensure that UE device 10B will be able to successfully decrypt the encrypted message (e.g., because UE device 10B possesses the identified sender key from its time on-grid but not the later sender key, which was transmitted by UE device 10A while UE device 10B was already off-grid).

If desired, UE device 10A may only store and track acknowledgements received from the UE devices 10 in set 18 that are known to UE device 10A to be capable of communicating via constellation 32 (e.g., without storing and/or tracking acknowledgements received from the UE devices 10 in set 18 that are known to UE device 10 to be incapable of communicating via constellation 32). In general, UE device 10A may track and use whichever previously transmitted sender key is still usable by the intended recipient UE device to encrypt messages transmitted to the intended recipient UE device.

FIG. 7 describes the transmission of MO messages by UE device 10A to UE devices 10 in set 18 for the sake of illustration. Similar operations may be performed to transmit MT messages from one of the UE devices 10 in set 18 to UE device 10A via constellation 32 (e.g., prior to, concurrent with, and/or after operations 120-126). The UE device 10 in set 18 may encrypt the MT messages using its own sender key, which was distributed to UE device 10A at operation 114 (e.g., the most recent iteration of operation 114 or the last usable iteration of operation 114). CN 20 may forward the MT messages to UE device 10A via constellation 32. UE device 10A may decrypt the MT messages using the sender key of the UE device 10 in set 18 that transmitted the MT messages (e.g., as received during an iteration of operation 114). The messaging application 80 on UE device 10A may then display the received MT messages using GUI 88 (FIG. 6).

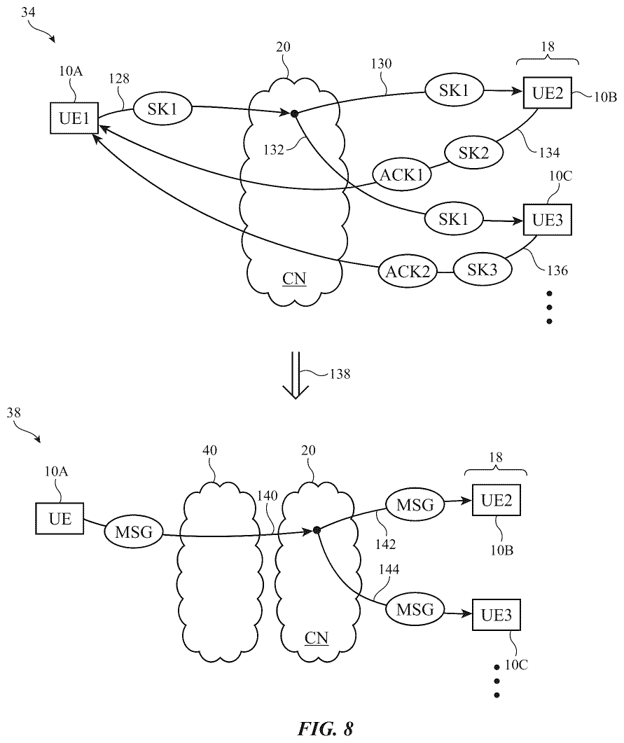

FIG. 8 is a diagram showing how sender keys may be distributed while UE device 10A is on-grid and how the sender keys may be used to convey an MO message from UE device 10A to the UE devices 10 in set 18 while UE device 10A is off-grid. As shown by arrow 128 of FIG. 8, UE device 10A may transmit a sender key SK1 associated with UE device 10A to CN 20 while UE device 10A is on-grid (e.g., while processing operation 112 of FIG. 7). CN 20 may distribute sender key SK1 to each UE device 10 in set 18. For example, CN 20 may transmit sender key SK1 to UE device 10B (as shown by arrow 130) and may concurrently transmit sender key SK1 to UE device 10C (as shown by arrow 132).

Each UE device 10 in set 18 may transmit a respective ACK message to the sender key SK1 received from UE device 10A. Each UE device 10 in set 18 may also transmit its own respective sender key to UE device 10A. For example, as shown by arrow 134, UE device 10B may transmit an ACK message ACK1 and its own sender key SK2 to UE device 10A via CN 20. Similarly, as shown by arrow 136, UE device 10C may transmit an ACK message ACK2 and its own sender key SK3 to UE device 10A via CN 20. Sender key SK3 may be different from sender key SK2 or may be the same as sender key SK2. UE device 10A may transmit ACK messages to each received sender key (not shown in FIG. 8 for the sake of clarity). UE device 10A may use ACK messages received from set 18 to identify the most recent usable sender key of UE device 10A to use in encrypting MO messages transmitted to set 18 while UE device 10A is off-grid. UE device 10A may use the sender keys SK2 and SK3 received from set 18 to decrypt MT messages transmitted by set 18 while UE device 10A is off-grid.

As shown by arrow 138, UE device 10A may go off-grid after sender keys SK1, SK2, and SK3 have been provisioned and distributed. UE device 10A may generate an MO message for receipt by the second user (set 18). UE device 10A may encrypt the MO message using its sender key SK1. UE device 10A may compress the encrypted MO message to produce compressed and encrypted message MSG. As shown by arrow 140, UE device 10A may transmit compressed and encrypted message MSG to CN 20 via NTN 40 (e.g., while processing operation 120 of FIG. 7).

UE device 10 may include a handle or handle index associated with the second user (set 18) in compressed and encrypted message MSG. CN 20 may identify each UE device 10 in set 18 (e.g., UE device 10B and UE device 10C) based on the handle or handle index in compressed and encrypted message MSG (e.g., while processing operation 122 of FIG. 7). CN 20 may transmit a copy of compressed and encrypted message MSG to each UE device 10 in set 18 via the terrestrial network. For example, CN 20 may transmit compressed and encrypted message MSG to UE device 10B (as shown by arrow 142) and may concurrently transmit compressed and encrypted message MSG to UE device 10C (as shown by arrow 144). UE devices 10B and 10C may use the sender key SK1 received from UE device 10A while UE device 10A was on-grid to decrypt compressed and encrypted message MSG. The UE devices 10 in set 18 may also transmit MT messages to UE device 10A (not shown) via CN 20 and NTN 40, which are then decrypted by UE device 10A using the sender keys of set 18 (e.g., sender key SK2 for MT messages transmitted by UE device 10B, sender key SK3 for MT messages transmitted by UE device 10C, etc.).

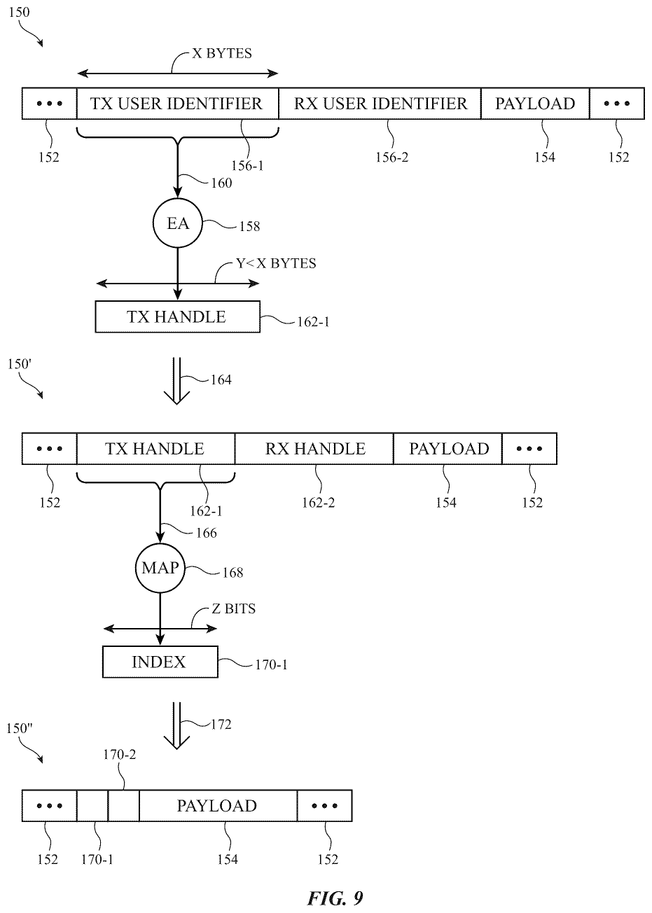

FIG. 9 is a diagram showing how UE device 10A may generate handles and handle indices that are used to convey messages between UE device 10 and one or more UE devices associated with the second user (e.g., UE device 10B in set 18). As shown in FIG. 9, UE device 10A may transmit a message 150 (e.g., a frame or datagram) for receipt by the second user (e.g., while UE device 10A is on-grid or off-grid). Message 150 may include a payload field 154, user identifiers 156, and other fields 152. Other fields 152 may include header fields, message integrity check fields, checksum fields, and/or any other desired fields. Payload field 154 may include a message payload (e.g., containing alphanumeric text, icons, tap-back messages, in-line reply messages, image data, video data, audio data, etc.).

User identifiers 156 may be included in a header (e.g., source or destination address fields) or other fields of message 150. User identifiers 156 may include first user identifier 156-1 associated with the first user and/or UE device 10A (e.g., in a transmitter (TX) address field or source address field of message 150). User identifiers 156 may include second user identifier 156-2 associated with the second user and/or UE device 10B (e.g., in a receiver (RX) address field or destination address field of message 150). First user identifier 156-1 may be, for example, an email address, profile name, or phone number associated with the first user. Second user identifier 156-2 may be, for example, an email address, profile name, or phone number associated with the second user. First user identifier 156-1 may be globally unique to the first user and/or UE device 10A. Second user identifier 156-2 may be globally unique to the second user and/or UE device 10B. User identifiers 156 are sometimes also referred to herein as full user identifiers, full handles, long user identifiers, or long handles.

Each user identifier 156 includes a string of characters. The string of characters can be excessively large and can consume an excessive amount of data. For example, each user identifier 156 may have a size (length) of X bytes (e.g., X=10-60 bytes, where each byte contains a series of 8 bits of binary values “1” or “0”). This may be particularly problematic when UE device 10A needs to transmit the message over a bandwidth-constrained network such as constellation 32. To reduce the size of the message, UE device 10A may use shorter handles such as handles 162 to address UE devices 10A and 10B instead of user identifiers 156.

UE device 10A may generate a first handle 162-1 identifying UE device 10A based on first user identifier 156-1. For example, as shown by arrow 160, UE device 10A may input first user identifier 156-1 to an encoding algorithm (EA) 158, which encodes the X bytes of first user identifier 156-1 into a first handle 162-1 of only Y bytes in size, where Y<X. Encoding algorithm 158 may, for example, include one or more mapping functions, encoding functions, cryptographic functions (e.g., hash functions), etc. First handle 162-1 may, for example, have a size of Y=1-10 bytes, which is less than the X bytes of first user identifier 156-1. UE device 10B may also generate a second handle 162-2 by inputting second user identifier 156-2 to encoding algorithm 158.

As shown by arrow 164, UE device 10A may generate and transmit a message 150′ (e.g., a frame or datagram) for receipt by the second user while UE device 10A is off-grid. Message 150′ may include payload field 154, other fields 152, and handles 162 instead of user identifiers 156. Handles 162 may include the first handle 162-1 associated with the first user and UE device 10A (e.g., generated using encoding algorithm 158 based on first user identifier 156-1). Handles 162 may also include the second handle 162-2 associated with the second user and UE device 10B (e.g., generated using encoding algorithm 158 based on second user identifier 156-2).

Handles 162 may be included in a header or other fields of message 150. First handle 162-1 is sometimes also referred to herein as the TX handle or source handle of message 150′ and may be included in a source or transmitter address field of message 150′, for example. Second handle 162-2 is sometimes also referred to herein as the RX handle or destination handle of message 150′ and may be included in a destination or receiver address field of message 150′, for example. Because handles 162-1 and 162-2 are each shorter than user identifiers 156-1 and 156-2, message 150′ is shorter than message 150 and is more easily conveyed over constellation 32 with minimal data loss and latency.

If desired, handles 162 may also help hide or obfuscate user identifiers 156 from other nodes of the network (e.g., preserving user privacy). If desired, handles 162 may be stored on UE device 10A and may be included in provisioning data transmitted to CN 20 (e.g., while processing operation 72 of FIG. 4). CN 20 may, for example, store handles 162 for different UE devices in user database 27 (FIG. 1). CN 20 may use the stored handles for routing messages between UE devices via terrestrial network 34 and/or NTN 40.

To further reduce the size of transmitted messages, UE device 10A may use handle indices such as handles indices 170 to address UE devices 10A and 10B instead of user identifiers 156 or handles 162. Each handle index 170 may include a respective series of only Z bits in size (e.g., Z=2 bits, 3 bits, 4 bits, 5 bits, 1-8 bits, or another number of bits less than Y bytes).

UE device 10A may generate a first handle index 170-1 identifying UE device 10A based on first handle 162-1. For example, as shown by arrow 166, UE device 10A may input first handle 162-1 to a mapping algorithm 168, which assigns and maps first handle 162-1 to a corresponding first handle index 170-1. First handle index 170-1 contains a series of only Z bits. UE device 10A may also input second handle 162-2 to mapping algorithm 168, which assigns and maps second handle 162-2 to a corresponding second handle index 170-2. Second handle index 170-2 also contains a series of only Z bits (e.g., Z bits having a different value than the Z bits in first handle index 170-1). UE device 10A may map/assign a different handle index 170 to each user in its contact list (e.g., using the handle generated from the user identifier from each user in its contact list).

As shown by arrow 172, UE device 10A may generate and transmit a message 150″ (e.g., a frame or datagram) for receipt by the second user while UE device 10A is off-grid. Message 150″ may include payload field 154, other fields 152, and handle indices 170 instead of user identifiers 156 or handles 162. Handle indices 170 may include the first handle index 170-1 associated with the first user and UE device 10A (e.g., generated using mapping algorithm 158 based on first handle 162-1). Handle indices 170 may also include the second handle index 170-2 associated with the second user and UE device 10B (e.g., generated using mapping algorithm 168 based on second handle 162-2).

Handle indices 170 may be included in a header or other fields of message 150. Handle index 170-1 is sometimes also referred to herein as the TX handle index or source handle index of message 150″ and may be included in a source or transmitter address field of message 150″, for example. Handle index 170-2 is sometimes also referred to herein as the RX handle index or destination handle index of message 150″ and may be included in a destination or receiver address field of message 150″, for example. Because handle indices 170-1 and 170-2 are each shorter than handles 162-1 and 162-2, message 150″ is shorter than message 150′ and is more easily conveyed over constellation 32 with minimal data loss and latency.

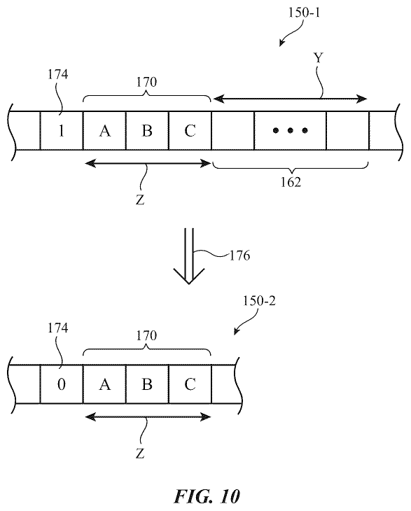

FIG. 10 is a diagram showing how a handle index 170 may be included in messages transmitted to CN 20 by UE device 10A while UE device 10A is off-grid. As shown in FIG. 10, UE device 10A may first transmit a message 150-1 to CN 20 via constellation 32 at a first time. Message 150-1 may include a handle index 170 (e.g., a TX handle index or RX handle index). Message 150-1 may also include the handle 162 associated with handle index 170 (e.g., where handle index 170 of FIG. 10 is generated by inputting handle 162 of FIG. 10 to mapping algorithm 168 of FIG. 9). Handle index 170 may include Z bits (e.g., three bits A, B, and C). If desired, handle index 170 may immediately precede handle 162 (e.g., handle 162 may include Y bytes immediately following the Z bits of handle index 170 in message 150-1).

Message 150-1 may also include a single handle assignment bit 174 associated with handle index 170 (e.g., each handle index 170 in message 150-1 may have a corresponding handle assignment bit 174). Handle assignment bit 174 may serve to instruct CN 20 to map or assign the following handle 162 in message 150-1 to its corresponding handle index 170 in message 150-1 (e.g., to inform CN 20 of the assignment of handle index 170 to handle 162). Handle assignment bit 174 may have a first value when the message includes handle 162 and when the message is intended to control CN 20 to assign the corresponding handle index 170 to the associated handle 162. Put differently, the first value of the handle assignment bit may indicate that the corresponding message is an assignment of the handle index in the message to the handle in the message. Handle assignment bit 174 may have a second value when the message does not include handle 162 and when the message is intended to control CN 20 to treat the handle index 170 as an addressing field (rather than assigning handle index 170 to a particular handle). Put differently, the second value of the handle assignment bit may indicate that the corresponding message is not an assignment of the handle index.

For example, as shown by arrow 176, UE device 10A may first transmit a message 150-2 to CN 20 via constellation 32 at a second time after the first time. Message 150-2 does not include handle 162 and its handle assignment bit 174 has the second value. The value of handle assignment bit 174 may instruct CN 20 to route message 150-2 based on handle index 170 (e.g., without assigning a new handle to handle index 170). Handle assignment bit 174 may, for example, be the bit immediately preceding the corresponding handle index 170 or may be elsewhere in the message.

Consider an example in which message 150-1 includes a handle index 170 of A=1, B=1, C=1, (e.g., the three-bit binary series “111”), a handle 162 associated with a first UE device other than UE device 10A, and a handle assignment bit 174 set to a first value (e.g., binary “1”). UE device 10A may transmit the message to CN 20 over constellation 32. CN 20 may identify that handle assignment bit 174 is set to the first value, which triggers CN 20 to store the associated handle index “111” as the handle index for the handle 162 associated with the first UE device. If UE device 10A then transmits another message 150-1 that includes a handle index 170 of A=1, B=1, C=0, (e.g., the three-bit binary series “110”), a handle 162 associated with a second UE device other than UE device 10A, and a handle assignment bit 174 set to the first value, CN 20 may identify that handle assignment bit 174 is set to the first value and may store the associated handle index “110” as the handle index for the handle 162 associated with the second UE device.

When UE device 10A later transmits a message 150-2 that includes a handle index 170 of “111,” a handle assignment bit 174 set to the second value (e.g., binary “0”), and no handles 162, CN 20 may use handle index “111” to determine where to forward the message (e.g., by mapping handle index “111” to the associated handle and by mapping the handle to the corresponding user identifier). Similarly, when UE device 10A later transmits a message 150-2 that includes a handle index 170 of “110,” a handle assignment bit 174 set to the second value, and no handles 162, CN 20 may use handle index “110” to determine where to forward the message (e.g., by mapping handle index “110” to the associated handle and by mapping the handle to the corresponding user identifier). In this way, UE device 10A may assign handle indices to different handles and thus different user identifiers and may utilize those handles to control routing for the messages while consuming as little data in the messages as possible.

The example of FIG. 10 is illustrative and non-limiting. Z may be two bits, a single bit, four bits, five bits, more than five bits, etc. If desired, handle assignment bit 174 may be formed as a part of handle index 170 (e.g., may be the first bit of handle index 170). In these scenarios, handle index 170 of FIG. 10 is a four-bit handle index having handle assignment bit 174 followed by three bits A, B, and C that uniquely identify the corresponding handle 162.

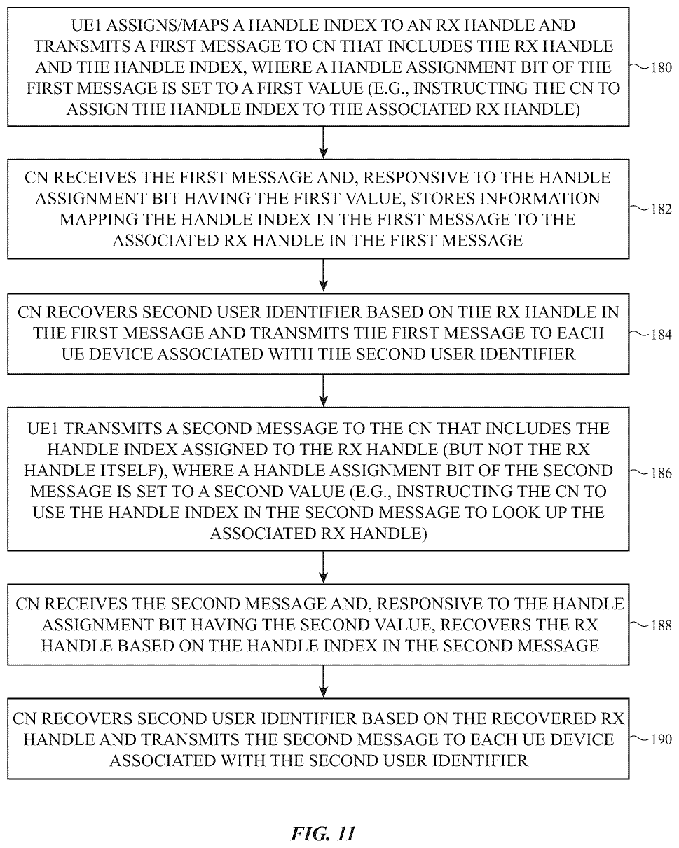

FIG. 11 is a flow chart of operations that may be performed by UE device 10A and CN 20 to convey messages from UE device 10 to the set 18 of UE devices 10 based on handle indices generated at UE device 10A. The operations of FIG. 11 may be performed while UE device 10A is off-grid (e.g., while processing operation 76 of FIG. 4 and/or operations 120-126 of FIG. 7).

At operation 180, UE device 10A (UE1) may identify an RX handle associated with the second user (e.g., handle 162-2 as generated using encoding algorithm 158 of FIG. 9 based on the second user identifier 156-2 associated with the second user and set 18). UE device 10A may assign/map the RX handle associated with the second user to a corresponding handle index (e.g., may generate handle index 170-2 of FIG. 9 by inputting the RX handle to mapping algorithm 168). UE device 10A may transmit a first message 150-1 (FIG. 10) to CN 20 via constellation 32 that includes the assigned/mapped handle index 170-2, the corresponding RX handle 162-2, and a handle assignment bit 174 set to a first value (e.g., binary “1”).

At operation 182, CN 20 may receive the first message 150-1 transmitted by UE device 10A via constellation 32. In response to the handle assignment bit 174 in first message 150-1 having the first value, CN 20 may store the handle index 170-2 for later use in routing messages between UE device 10A and set 18 (e.g., CN 20 may store, in user database 27 of FIG. 1, handle index 170-2 and information mapping or relating handle index 170-2 to the RX handle 162-2 in first message 150-1).

At operation 184, CN 20 may recover (e.g., look up, identify, output, generate, produce, etc.) the second user identifier associated with the second user of set 18 based on the RX handle 162-2 in first message 150-1 (e.g., using handles as provisioned while processing operation 72 of FIG. 4). CN 20 may recover a list of UE devices 10 in set 18 (e.g., in user database 27). CN 20 may then forward (fan out) first message 150-1 to each of the UE devices 10 in the list over network portion 22 (e.g., to each of the UE devices 10 in set 18 and associated with the second user identifier).

At operation 186, UE device 10A may generate a second message 150-2 (FIG. 10) for receipt by each UE device of the second user (e.g., each of the UE devices 10 in set 18). UE device 10A may include the handle index 170-2 associated with the second user (e.g., as generated at operation 180) in second message 150-2. UE device 10A may set the handle assignment bit 174 of second message 150-2 to a second value (e.g., binary “0”). Second message 150-2 does not include handle 162 (e.g., may be free from user identifiers 156 or handles 162) to minimize the size of the message. UE device 10A may transmit second message 150-2 to CN 20 via constellation 32.

At operation 188, CN 20 may receive the second message 150-2 transmitted by UE device 10A via constellation 32. In response to the handle assignment bit 174 in second message 150-2 having the second value, CN 20 may recover (e.g., look up, identify, output, generate, produce, etc.) the RX handle 162-2 associated with the handle index 170-2 in second message 150-2 (e.g., by searching user database 27 as updated while processing operation 182).

At operation 190, CN 20 may recover (e.g., look up, identify, output, generate, produce, etc.) the second user identifier associated with the second user of set 18 based on the RX handle 162-2 recovered from the handle index 170-2 in second message 150-2. CN 20 may then forward (fan out) second message 150-2 to each of the UE devices 10 in the list over network portion 22 (e.g., to each of the UE devices 10 in set 18 and associated with the second user identifier).

In some situations, the messages conveyed by UE device 10A using messaging application 80 each include a respective message identifier that uniquely identifies that particular message (e.g., in a packet number field, message number field, message identifier field, etc.). The message identifiers may be used to perform packet re-ordering, to perform packet de-duplication, and to transmit and/or receive messages that reference earlier transmitted or received messages (e.g., in-line replies, tap-backs, etc.). However, if care is not taken, message identifiers can consume excessive data, which can increase latency, data loss, and detriment to user experience in communicating via constellation 32. If desired, UE device 10 may utilize unique effective identifiers to perform packet re-ordering, to perform packet de-duplication, and/or to transmit and/or receive messages that reference earlier transmitted or received messages (e.g., without including message identifiers in the messages).

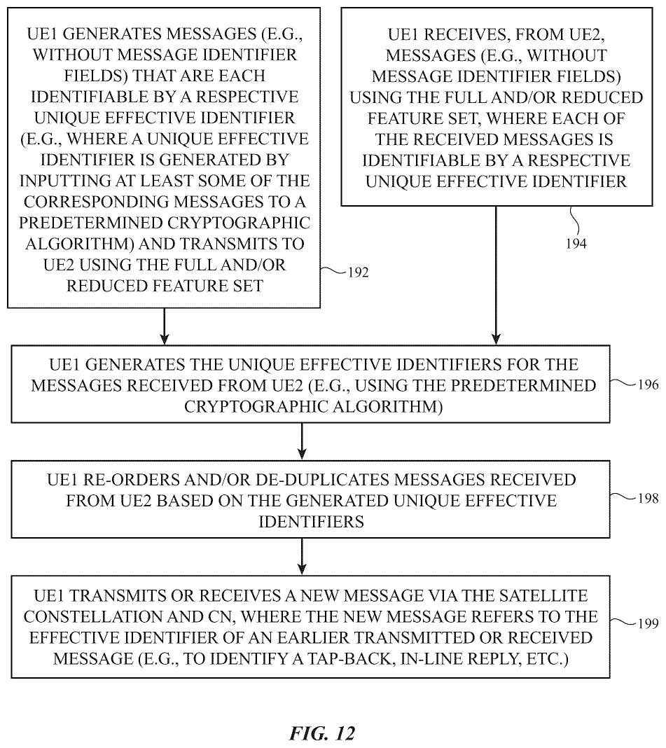

FIG. 12 is a flow chart of illustrative operations that may be performed by UE device 10A to convey messages based on unique effective identifiers. Operations 192-199 may, for example, be performed while UE device 10A is on-grid (e.g., at operation 70 of FIG. 4) and/or while UE device 10A is off-grid (e.g., at operation 76 of FIG. 4, operations 120-126 of FIG. 7, etc.).

At operation 192, which may be performed prior to, after, or concurrent with operation 194, UE device 10A (UE1) may generate messages (e.g., MO messages) for transmission to another UE device such as UE device 10B (UE2). The messages may be free from message identifier fields (e.g., there are no message identifiers in the messages). Instead, each of the messages may be identifiable by a respective unique effective identifier. The unique effective identifiers are not included in the messages but can be used to perform packet re-ordering, packet de-duplication, and/or reference earlier messages. The unique effective identifier for a given message may be generated at UE device 10A by inputting at least some of the message (e.g., at least some of one or more message fields, the payload, etc.) to a predetermined cryptographic algorithm (e.g., one or more cryptographic functions, hashing functions, encoding operations, etc.). UE device 10A may transmit the messages to UE device 10B via constellation 32 and CN 20 while off-grid (e.g., using reduced feature set 84 of FIG. 5) and/or via the terrestrial network while on-grid (e.g., using full feature set 82 of FIG. 5).

At operation 194, UE device 10A may receive messages (e.g., MT messages) from UE device 10B. The messages may be free from message identifier fields (e.g., there are no message identifiers in the messages). Instead, each of the messages may be identifiable by a respective unique effective identifier. The unique effective identifier for a given message may be generated at UE device 10B by inputting at least some of the message to the predetermined cryptographic algorithm. UE device 10B may transmit the messages to UE device 10A via constellation 32 and CN 20 while UE device 10A is off-grid (e.g., using reduced feature set 84 of FIG. 5) and/or via the terrestrial network while UE device 10A is on-grid (e.g., using full feature set 82 of FIG. 5).

At operation 196, UE device 10A may generate the unique effective identifiers for the messages received from UE device 10B (e.g., by inputting the received messages to the predetermined cryptographic algorithm). UE device 10B may also generate unique effective identifiers for the messages transmitted by UE device 10A (e.g., using the predetermined cryptographic algorithm). The predetermined cryptographic algorithm may, for example, incorporate unique cryptographic properties such as counters (e.g., ratchet counters), authentication tag generations, sender keys, and/or a combination of other cryptographic characteristics that need to be unique to not be rejected by the cryptographic algorithm. Both the sender and receiver device may independently generate the same unique effective identifiers (e.g., using the predetermined cryptographic algorithm) to reference each conveyed message at some point in the future.

At operation 198, UE device 10A may re-order messages received from UE device 10B based on the unique effective identifiers. The unique effective identifiers may, for example, identify the order with which UE device 10B transmitted the messages to UE device 10A. UE device 10A may use this order to ensure that the messages are displayed on GUI 88 (FIG. 6) in the correct order with which UE device 10B transmitted the messages. This may help to mitigate situations where UE device 10A successfully received the messages out of order via constellation 32, situations where UE device 10A did not successfully received one or more of the messages from constellation 32, etc.

Additionally or alternatively, UE device 10A may de-duplicate messages received from UE device 10B based on the unique effective identifiers. For example, if/when UE device 10A detects that it has received multiple messages with the same unique effective identifier, UE device 10A may delete copies or duplicates of the message(s), ensuring that only a single copy of each received message is displayed by GUI 88. This may help to mitigate situations where UE device 10A receives multiple copies of a given message via constellation 32, such as when propagation conditions do not allow CN 20 to successfully receive acknowledgement messages to each of the MT messages transmitted to UE device 10A over constellation 32, causing the CN to needlessly re-transmit one or more of the MT messages to UE device 10A.

At operation 199, UE device 10A may transmit or receive a new message via constellation 32 and CN 20 while UE device 10A is off-grid. The new message may reference an earlier transmitted or received message by referring to the unique effective identifier of the earlier transmitted or received message. The new message may include, for example, an in-line reply message (see, e.g., in-line reply 98 of FIG. 6) or a tap-back message (see, e.g., graphical element 96 of FIG. 6). In this way, UE device 10A may perform reliable and secure complex messaging with UE device 10B (e.g., using reduced feature set 84) while minimizing the amount of data in each message, which minimizes latency and maximizes the likelihood that the messages are successfully received while UE device 10A is off-grid. Operations 199 and/or 198 may be omitted if desired.

If desired, the availability of UE device 10A to communicate with another UE device such as UE device 10B via constellation 32 may be characterized by a corresponding satcom status. UE device 10A may transmit status messages to CN 20 that identify its current satcom status. CN 20 may forward the status messages to UE device 10B so the second user of UE device 10B has knowledge that UE device 10A is off-grid and/or available to communicate before conveying subsequent messages between UE device 10A and UE device 10B via constellation 32. This may, for example, allow the second user of UE device 10B to confirm that the second user actually wishes to use reduced feature set 84 rather than full feature set 82 (FIG. 5) in conveying messages with UE device 10A while UE device 10A is off-grid. A user may not wish to convey messages via constellation 32, for example, when the user does not have sufficiently urgent messages to consume the satellite bandwidth of UE device 10A, when the user does not wish to subscribe to satellite communications services, when the user wishes to only communicate using a full suite of security options supported by full feature set 82, etc.

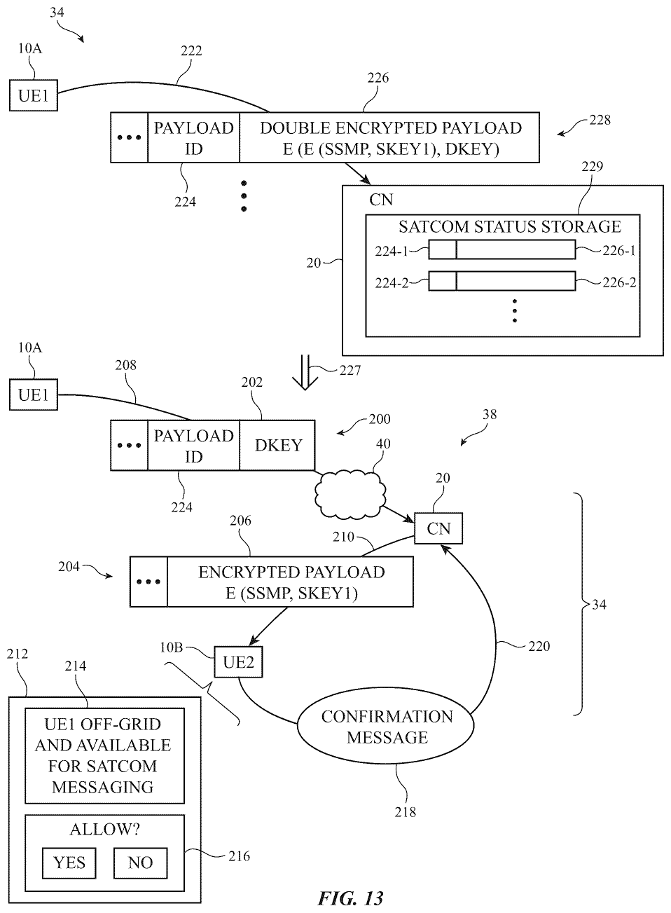

To help minimize the amount of data conveyed over constellation 32 while UE device 10A is off-grid, UE device 10A may pre-provision satcom status messages with CN 20 while on-grid and may use much smaller status control messages to release the pre-provisioned satcom status messages after UE device 10A has gone off-grid. FIG. 13 is a diagram showing how UE device 10 may pre-provision and release satcom status messages.

As shown in the top half of FIG. 13, while UE device 10A is on-grid, UE device 10A may generate satcom status provisioning messages 228. Each satcom status provisioning message 228 may include a double-encrypted payload 226 and a corresponding payload identifier (ID) 224 that identifies its double-encrypted payload. Each double-encrypted payload 226 may include a satcom status message payload SSMP (e.g., information identifying a potential satcom status of UE device 10A). Each satcom status message payload SSMP may include, for example, a text or alphanumeric string identifying a particular satcom status for UE device 10A. Examples of satcom status message payloads SSMP include strings such as “OFF-GRID AND AVAILABLE FOR SATELLITE COMMUNICATIONS,” “OFF-GRID AND UNAVAILABLE FOR SATELLITE COMMUNICATIONS,” “OFFLINE,” “ONLINE,” and/or other messages indicative of the availability of UE device 10A to communicate via constellation 32.

UE device 10A may perform a first layer of encryption on a satcom status message payload SSMP using its sender key SKEY1 (e.g., sender key SK1 of FIG. 8). For example, UE device 10A may apply an encryption function E on satcom status message payload SSMP based on sender key SKEY1, which outputs an single-encrypted payload E(SSMP, SKEY1). UE device 10A may then perform a second layer of encryption on the satcom status message payload using an unshared device key DKEY. For example, UE device 10A may apply an encryption function E on the single-encrypted payload E(SSMP, SKEY1) based on device key DKEY, which outputs a double-encrypted payload 226 (e.g., as E(E(SSMP, SKEY1), DKEY)). Payload ID 224 may be unencrypted. Device key DKEY is sometimes also referred to herein as escrow key DKEY.

As shown by arrow 222, UE device 10A may transmit satcom status provisioning messages 228 to CN 20 over terrestrial network 34 while UE device 10A is on-grid (e.g., while processing operation 72 of FIG. 4). CN 20 may store the satcom status provisioning messages 228 transmitted by UE device 10A in satcom status storage 229. Satcom status storage 229 may, for example, store a first double-encrypted payload 226-1 and a corresponding payload ID 224-1 received from UE device 10A, a second double-encrypted payload 226-2 and a corresponding payload ID 224-2, etc. Satcom status message payload SSMP may include a relatively large amount of data. By offloading the transmission of satcom status message payloads SSMP to CN 20 while UE device 10A is on-grid, UE device 10A does not need to transmit satcom status message payloads SSMP to CN 20 while off-grid, conserving satellite-based data usage while UE device 10A is off-grid.

As shown by arrow 227, UE device 10A may move off-grid at some time after transmitting satcom status provisioning messages 228 to CN 20 over terrestrial network 34. As shown by arrow 208, while off-grid, UE device 10A may transmit a control message such as satcom status message 200 to CN 20 over NTN 40. Satcom status message 200 may serve to inform UE device 10B of the current satcom status of UE device 10A. Satcom status message 200 may include a field 202 that contains the device key DKEY used by UE device 10A to perform the second layer of encryption on the double-encrypted payloads 226 of the satcom status provisioning messages 228 transmitted while UE device 10A was on-grid. Satcom status message 200 may also include the payload identifier 224 associated with one of the double-encrypted payloads 226 stored on CN 20 (e.g., the double-encrypted payload 226 that contains the satcom status message payload SSMP that identifies the current satcom status of UE device 10A). Because there are no satcom status message payloads SSMP in satcom status message 200, UE device 10A consumes a minimal amount of data and bandwidth in transmitting satcom status message 200 over NTN 40.

CN 20 may receive satcom status message 200 from NTN 40. CN 20 may retrieve the stored double-encrypted payload 226 identified by the payload identifier 224 in satcom status message 200 from satcom status storage 229. CN 20 may remove the second layer of encryption on the identified double-encrypted payload 226 by decrypting the double-encrypted payload 226 using the device key DKEY in the received satcom status message 200. This may produce a single-encrypted payload 206 (e.g., E(SSMP, SKEY1)). Double-encrypting satcom status message payloads SSMP may shield the current satcom statuses of UE device 10A from CN 20, helping to preserve privacy for the first user. As shown by arrow 208, CN 20 may transmit a satcom status message 204 to UE device 10B that includes single-encrypted payload 206.

UE device 10B may use the sender key SKEY1 of UE device 10A (e.g., as received while processing operation 72 of FIG. 4 and operation 112 of FIG. 7) to decrypt the single-encrypted payload 206 of the received satcom status message 204, outputting its unencrypted satcom status message payload SSMP. The messaging application 80 (FIG. 6) on UE device 10B may display the unencrypted satcom status message payload SSMP on GUI 212 (e.g., using graphical element 214, which may include text, a notification, a banner, an icon, a badge, graphics, etc.). This may serve to inform the second user of the current satcom status of UE device 10A.

If desired, GUI 212 may also display a confirmation graphic 216 to confirm whether the second user wishes to allow satellite-based messages to be conveyed with UE device 10A given its current satcom status. As shown by arrow 220, UE device 10B may transmit a confirmation message 218 to CN 20. Confirmation message 218 may acknowledge receipt of satcom status message 204. If desired, confirmation message 218 may also include information identifying whether UE device 10B has received a user input (e.g., responsive to confirmation graphic 216) that confirms or denies subsequent messaging with UE device 10A via NTN 40. If/when confirmation message 218 confirms subsequent messaging with UE device 10A, CN 20 may proceed to route subsequent messages between UE device 10A and UE device 10B over NTN 40. If/when confirmation message 218 denies subsequent messaging with UE device 10A, CN 20 may not route subsequent messages between UE device 10A and UE device 10B over NTN 40. If desired, CN 20 may store messages in its message queue for delivery once UE device 10A has gone back on-grid.

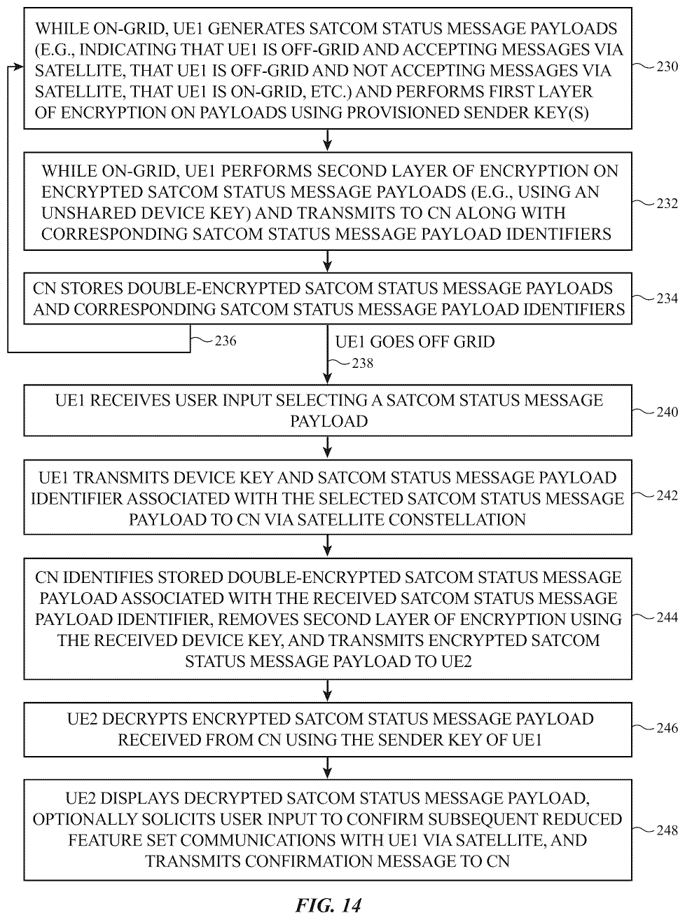

FIG. 14 is a flow chart of illustrative operations involved in pre-provisioning satcom status messages for UE device 10A and in releasing satcom status messages to UE device 10B when UE device 10B is off-grid. Operations 230-234 of FIG. 14 may, for example, be performed while processing operation 72 of FIG. 4. Operations 240-248 of FIG. 14 may, for example, be performed while processing operation 76 of FIG. 4 and/or may be performed prior to, concurrent with, or after operations 120-126 of FIG. 7.

At operation 230, while on-grid, UE device 10A may generate a set of different satcom status message payloads SSMP, each indicative of a different possible satcom status of UE device 10A. UE device 10A may perform a first layer of encryption on each satcom status message payloads SSMP using the sender key(s) distributed to other UE devices while processing operation 72 of FIG. 4. This may produce single-encrypted payloads E(SSMP, SKEY1).

At operation 232, while on-grid, UE device 10A may perform a second layer of encryption on each single-encrypted payload E(SSMP, SKEY1) using its device key DKEY, producing double-encrypted payloads 226 (e.g., E(E(SSMP, SKEY1), DKEY)). UE device 10A may transmit double-encrypted payloads 226 and corresponding payload identifiers 224 to CN 20 in one or more satcom status provisioning messages 228.

At operation 234, CN 20 may store the double-encrypted payloads 226 and the corresponding payload identifiers 224 from satcom status provisioning messages 228 in satcom status storage 229. While UE device 10A remains on-grid, processing may loop back to operation 230 via path 236 to re-provision double-encrypted payloads 226 (e.g., periodically, every 24 hours, every 30 hours, every 60 hours, every 5 days, every 7 days, every 30 days, every 40 days, every 60 days, whenever UE device 10A powers on, whenever a sender key is set to expire, etc.). In this way, UE device 10A may periodically re-generate, refresh, and/or rotate the double-encrypted payloads 226 stored on CN 20 (e.g., as the sender key SKEY1 and/or device key DKEY of UE device 10A are refreshed over time). Processing may proceed from operation 234 to operation 240 via path 238 if/when UE device 10A goes off-grid.

At operation 240, UE device 10A may receive a user input or application call selecting a current satcom status of UE device 10A and/or the corresponding satcom status message payload SSMP.

At operation 242, UE device 10A may select or identify the payload identifier 224 associated with the selected satcom status and/or satcom status message payload SSMP (e.g., the payload identifier 224 corresponding to the double-encrypted payload 226 that included the selected satcom status message payload SSMP). UE device 10A may generate a satcom status message 200 that includes the selected payload identifier 224. UE device 10A may include its current device key DKEY in field 202 of satcom status message 200. UE device 10A may transmit satcom status message 200 to CN 20 via constellation 32.

At operation 244, CN 20 may receive satcom status message 200 via constellation 32. CN 20 may identify (e.g., select or retrieve) the double-encrypted payload 226 in satcom status storage 229 that corresponds to or that is identified by the selected payload identifier 224 included in satcom status message 200. CN 20 may decrypt the identified double-encrypted payload 226 using the device key DKEY included in satcom status message 200, recovering the single-encrypted payload 206 (e.g., E(SSMP, SKEY1)) of the identified double-encrypted payload 226. CN 20 may generate a satcom status message 204 that includes the recovered single-encrypted payload 206. CN 20 may transmit satcom status message 204 to UE device 10B over the terrestrial network.

At operation 246, UE device 10B may receive satcom status message 204 from CN 20. UE device 10B may decrypt the single-encrypted payload 206 in satcom status message 204 using the sender key SKEY1 of UE device 10A (e.g., the same sender key used by UE device 10A to perform the first layer of encryption on satcom status message payload SSMP while processing operation 230). This may recover the selected satcom status message payload SSMP corresponding to the current satcom status of UE device 10A (e.g., as selected by the user of UE device 10A).

At operation 248, UE device 10B may display the selected satcom status message payload SSMP on GUI 212. This may serve to inform the user of UE device 10B of the current satcom status of UE device 10A. If desired, GUI 212 may also display confirmation graphic 216 to solicit a user input that confirms or denies subsequent satellite-based messaging with UE device 10A given its current satcom status. UE device 10B may transmit confirmation message 218 to CN 20. Confirmation message 218 may acknowledge receipt of satcom status message 204. If desired, confirmation message 218 may also include information identifying whether UE device 10B has received a user input confirming or denying subsequent messaging with UE device 10A via constellation 32.

CN 20 may deliver MT messages to UE device 10A from message queue 25 (FIG. 1) according to a particular order or prioritization. For example, CN 20 may transmit earlier messages in message queue 25 to UE device 10A prior to transmitting later messages in message queue 25 (e.g., using a time-based prioritization). If desired, CN 20 may prioritize messages in message queue 25 generated by certain applications, that contain certain types of data, that are transmitted by particular sources, and/or that contain an emergency or urgency flag to UE device 10A prior to other messages in message queue 25. For example, CN 20 may prioritize messages in message queue 25 that include a relatively low amount of data over messages that include a relatively high amount of data, may prioritize messages from emergency service providers, may prioritize text-based messages over audio, image, or video-based messages, may prioritize message data over non-message data (e.g., internet browsing data or other application data), etc.

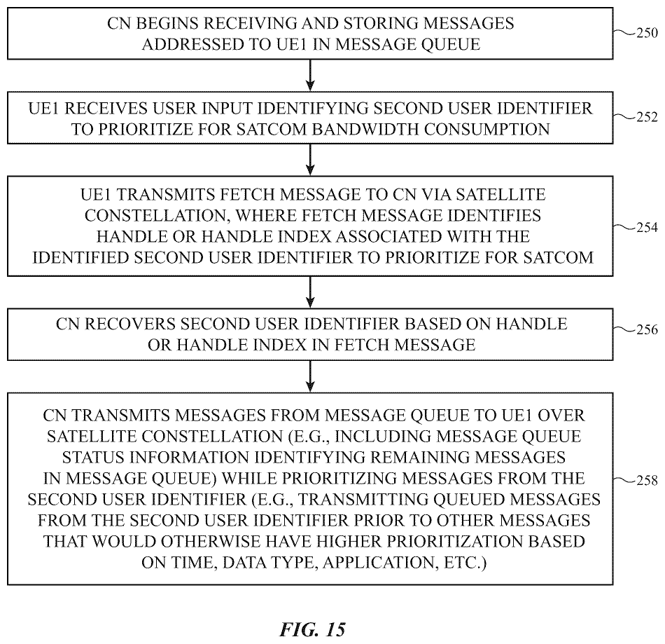

If desired, UE device 10A may transmit a fetch message to CN 20 that identifies a particular user to prioritize for consuming satcom bandwidth and data. FIG. 15 is a flow chart of operations that may be performed by UE device 10A and CN 20 to prioritize messages based on a fetch message transmitted by UE device 10A. The operations of FIG. 15 may be performed while UE device 10A while UE device 10A is off-grid (e.g., while processing operation 76 of FIG. 4).

At operation 250, CN 20 may begin receiving and storing MT messages addressed to UE device 10A in message queue 25.

At operation 252, UE device 10A (UE1) may receive a user input or an application call identifying or selecting a particular second user to prioritize for satcom operations. The selected second user may be, for example, the second user associated with the UE devices 10 in set 18 (FIG. 1). The selected second user may be a user from the contacts list on UE device 10A. The selected second user may be, for example, a particular family member or emergency contact of the first user of UE device 10A.

At operation 254, UE device 10A may transmit a fetch message to CN 20 via constellation 32. To minimize data consumption and bandwidth, the fetch message may include or identify the handle (e.g., handle 162 of FIG. 9) associated with the selected second user or the handle index (e.g., handle index 170 of FIG. 9) associated with the selected second user.

At operation 256, CN 20 may recover or identify the second user identifier associated with the selected second user based on the handle or handle index included in the fetch message.

At operation 258, CN 20 may search message queue 25 for MT messages transmitted by the second user identifier. CN 20 may transmit any of the MT messages received from the second user identifier in message queue 25 to UE device 10A via constellation 32 prior to other MT messages in message queue 25 regardless of time or prioritization. Put differently, CN 20 may transmit MT messages in message queue 25 from the selected second user prior to earlier received MT messages, prior to MT messages of a higher priority data type, prior to MT messages produced by a higher priority application, prior to MT messages that are from an emergency services provider, prior MT messages having an emergency or urgency flag, etc.

If desired, UE device 10A may transmit any of the MO messages described herein using a multi-part message transmission scheme. Under the multi-part message transmission scheme, when a given MO message exceeds a minimum threshold size (e.g., associated with the bandwidth of constellation 32) after encryption and compression, messaging application 80 may divide the MO message into multiple parts. UE device 10A may encrypt and compress each part and may transmit the parts to CN 20 via constellation 32 in separate messages. Each part may be identified using a corresponding part number (e.g., a few bits in size) and each message may include the corresponding part number and information identifying how many parts remain from the original MO message. Alternatively, UE device 10A may compress all of the text from the MO message, may encrypt all of the compressed text, and may then break the compressed and encrypted text into different parts. The receiving UE device may use the part numbers to re-order and/or de-duplicate the parts to obtain the original MO message. Each of the parts may be addressed using handles or handle indices.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.” CN 20 may have a first communications interface with satellite constellation 32 (e.g., through/over terrestrial network 34 and gateway 14) and may have a second communications interface with terrestrial-based communications equipment 21 (e.g., through/over terrestrial-based communications equipment 21 and terrestrial network 34). CN 20 may convey wireless data with UE device 10A using or via its first communications interface with satellite constellation 32. CN 20 may convey wireless data with UE device 10A using or via its second communications interface with terrestrial based communications equipment 21 (e.g., while UE device 10A is on grid).

One or more elements described herein (e.g., UE devices 10, satellites 12, gateways 14, CN 20, etc.) may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-15 may be performed using software, firmware, and/or hardware (e.g., dedicated circuitry or hardware). Software code for performing these operations may be stored on non-transitory computer readable storage media (e.g., tangible computer readable storage media) stored on one or more of the components of communications system 38 (e.g., storage circuitry 46 of FIG. 2 or similar storage circuitry on satellites 12, gateways 14, CN 20, etc.). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of communications system 38 (e.g., processing circuitry 48 of FIG. 2 or similar processing circuitry on satellites 12, gateways 14, CN 20, etc.). The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth herein. For example, the control circuitry as described above in connection with one or more of the preceding figures may be configured to operate in accordance with one or more of the examples set forth herein. For another example, circuitry associated with a UE, satellite, gateway, core network, base station, network element, etc. as described above in connection with one or more of the preceding figures may be configured to operate in accordance with one or more of the examples set forth herein.

An apparatus (e.g., an electronic user equipment device, a wireless base station, etc.) may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus comprising logic, modules, or circuitry to perform one or more elements of a method described in or related to any of the method or process described herein.

An apparatus comprising: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

For one or more aspects, at least one of the components set forth in one or more of the preceding figures may be configured to perform one or more operations, techniques, processes, or methods as set forth in the example section below.

### Examples

In the following sections, further exemplary aspects are provided.

Example 1 includes a method of operating a first user equipment (UE) device, comprising: transmitting, using an antenna, a first message intended for a second UE device via a constellation of communications satellites and a core network, wherein the first message includes a handle associated with the second UE device, a handle index corresponding to the handle, the handle index being smaller than the handle, and a handle assignment bit associated with the handle index.

Example 2 includes the method of example 1, wherein the handle uniquely identifies the second UE device but is smaller than a corresponding unique user identifier associated with the second UE device.

Example 3 includes the method of example 2, further comprising: generating, using one or more processors, the handle based at least on the unique user identifier associated with the second UE device.

Example 4 includes the method of example 3, wherein the unique user identifier comprises a profile name, an email address, or a Mobile Station International Subscriber Directory Number associated with the second UE device.

Example 5 includes the method of example 3, wherein the unique user identifier has a first size between 10 bytes and 60 bytes, the handle has a second size between 1 byte and 10 bytes, and the handle index comprises between 1 and 8 bits.

Example 6 includes the method of example 1, further comprising: instructing, using the handle assignment bit, the core network to assign the handle index to the handle for use in routing a subsequent message between the first and second UE devices via the constellation of communications satellites.

Example 7 includes the method of example 1, further comprising: transmitting, using the antenna, a second message intended for the second UE device via the constellation of communications satellites and the core network, wherein the second message includes the handle index and the handle assignment bit but does not include the handle.

Example 8 includes the method of example 7, wherein the handle assignment bit precedes the handle index in the second message, the handle assignment bit has a first value in the first message, and the handle assignment bit has a second value in the second message that is different from the first value.

Example 9 includes the method of example 7, further comprising: transmitting, using the antenna, a third message intended for the second UE device via the constellation of communications satellites and the core network, wherein the third message includes the handle index and the handle assignment bit, and the third message references the second message using a unique effective identifier that is not included in the second message.

Example 10 includes the method of example 9, wherein the third message comprises an in-line reply to the second message or a tap-back to the second message.

Example 11 includes the method of example 1 wherein, in the first message, the handle assignment bit precedes the handle index and the handle index precedes the handle.

Example 12 includes the method of example 1, further comprising: transmitting, using the antenna, a fetch message to the core network via the constellation of communications satellites, wherein the fetch message identifies a third UE device to be prioritized by the core network over the second UE device for transmission of mobile terminated messages to the first UE device via the constellation of communications satellites.

Example 13 includes a method of operating a first user equipment (UE) device, comprising: transmitting, using one or more antennas, information identifying a satellite communications status of the first UE device to a core network via terrestrial-based communications equipment; and transmitting, using the one or more antennas, a control message to the core network via a constellation of communications satellites, wherein the control message instructs the core network to transmit, to a second UE device, the information identifying the satellite communications status of the first UE device.

Example 14 includes the method of example 13, further comprising: generating, using one or more processors, a single-encrypted payload by encrypting the information identifying the satellite communications status of the first UE device based on a first cryptographic key; generating, using the one or more processors, a double-encrypted payload by encrypting the single-encrypted payload based on a second cryptographic key; and transmitting, using the one or more antennas, the double-encrypted payload to the core network via the terrestrial-based communications equipment.

Example 15 includes the method of example 14, further comprising: transmitting, using the one or more antennas, the first cryptographic key to the second UE device via the terrestrial-based communications equipment.

Example 16 includes the method of example 15, further comprising: transmitting, using the one or more antennas, an identifier associated with the double-encrypted payload to the core network via the terrestrial-based equipment.

Example 17 includes the method of example 16, wherein the control message transmitted to the core network via the constellation of communications satellites comprises the second cryptographic key and the identifier.

Example 18 includes a method of operating a user equipment (UE) device comprising: transmitting, to a core network via terrestrial-based communications equipment, a set of different satellite communications status message payloads; and transmitting, to the core network via a constellation of communications satellites, a control message that identifies a particular satellite communications status message payload from the set of different satellite communications status message payloads.

Example 19 includes the method of example 18, further comprising: receiving an input indicating the particular satellite communications status message payload identified by the control message.

Example 20 includes the method of example 18, further comprising: encrypting, using one or more processors, the set of different satellite communications status message payloads based at least on a cryptographic key prior to transmitting the set of different satellite communications status message payloads to the core network; and transmitting the cryptographic key to the core network via the constellation of communications satellites.

Example 21 includes a method of operating a server, comprising: forwarding, to a second user equipment (UE) device and a third UE device, a cryptographic key transmitted by a first UE device to terrestrial-based communications equipment, the first UE device being associated with a first user identifier and the second and third UE devices being associated with a second user identifier different from the first user identifier; and forwarding, to the second UE device and the third UE device, a message transmitted by the first UE device to a satellite constellation, the message being encrypted by the first UE device using the cryptographic key.

Example 22 includes the method of example 21, wherein the message comprises a handle index and a handle assignment bit, the method further comprising: forwarding the message to the second UE device and the third UE device based on the handle index and the handle assignment bit.

Example 23 includes the method of example 22, wherein the message further comprises a handle associated with the second user identifier, the handle is shorter than the second user identifier, and the method further comprises: responsive to the handle assignment bit having a predetermined value, storing information mapping the handle index to the handle.

Example 24 includes the method of example 21, further comprising: forwarding a first acknowledgment to the cryptographic key from the second UE device to the first UE device via the terrestrial-based communications equipment; and forwarding a second acknowledgment to the cryptographic key from the third UE device to the first UE device via the terrestrial-based communications equipment.

Example 25 includes the method of example 21, further comprising: forwarding a first additional cryptographic key from the second UE device to the first UE device via the terrestrial-based communications equipment; and forwarding a second additional cryptographic key from the third UE device to the first UE device via the terrestrial-based communications equipment.

Example 26 includes the method of example 21, wherein the terrestrial-based communications equipment comprises a wireless base station or a wireless access point.

Example 27 includes a method of operating a server, comprising: receiving, using a communications interface with a satellite constellation, a first message transmitted by a first user equipment (UE) device, wherein the first message comprises a handle associated with a second UE device, a handle index associated with the handle, and a handle assignment bit having a first value; storing, at storage circuitry, information mapping the handle index to the handle; and forwarding the first message to the second UE device via a terrestrial network.

Example 28 includes the method of example 27, wherein the handle uniquely identifies the second UE device but is smaller than a corresponding unique user identifier associated with the second UE device.

Example 29 includes the method of example 27, further comprising: receiving, using the communications interface with the satellite constellation, a second message transmitted by the second UE device, wherein the second message comprises the handle index and the handle assignment bit but not the handle, the handle assignment bit in the second message having a second value that is different than the first value.

Example 30 includes the method of example 29, wherein the handle index comprises between 1 and 8 bits and wherein the handle assignment bit precedes the handle in the second message.

Example 31 includes the method of example 29, further comprising: identifying the handle based on the handle index in the second message and based on the stored information; identifying a destination address of the second UE device based on the identified handle; and forwarding the second message to the identified destination address.

Example 32 includes the method of example 29, wherein the handle index is shorter than the handle.

Example 33 includes the method of example 32, wherein the handle assignment bit precedes the handle index in the first message and wherein the handle index precedes the handle in the first message.

Example 34 includes the method of example 31, wherein the handle index comprises at least three bits.

Example 35 includes a method of operating a server, comprising: receiving, using a communications interface with terrestrial-based communications equipment, a set of different satellite communications status message payloads transmitted by a first user equipment (UE) device to the terrestrial-based communications equipment; storing, at storage circuitry, the set of different satellite communications status message payloads; and receiving, using a communications interface with a satellite constellation, a control message transmitted by the first UE device to the satellite constellation, wherein the control message identifies a particular satellite communications status message payload from the set of different satellite communications status message payloads stored at the storage circuitry.

Example 36 includes the method of example 35, further comprising: receiving, using the communications interface with the satellite constellation, a message intended for a second UE device that was transmitted by the first UE device; and transmitting, to the second UE device via a terrestrial network, the message and the particular satellite communications status message payload identified by the control message.

Example 37 includes the method of example 36, wherein the particular satellite communications status message payload is double-encrypted by the first UE device, the control message comprises a cryptographic key, and the method further comprises: decrypting the particular satellite communications status message payload using the cryptographic key to recover a single-encrypted satellite communications status message payload; and transmitting, to the second UE device via the terrestrial network, the single-encrypted satellite communications status message payload.

Example 38 includes the method of example 35, wherein storing the set of different satellite communications status payloads comprises storing payload identifiers for each of the different satellite communications status payloads and wherein the control message comprises one of the payload identifiers.

Example 39 includes the method of example 35, wherein the terrestrial-based communications equipment comprises a wireless base station or a wireless access point.

Example 40 includes the method of example 35, further comprising: transmitting, to a second UE device via a terrestrial network, the particular satellite communications status message payload identified by the control message.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

The foregoing is merely illustrative and various modifications can be made to the described embodiments. The foregoing embodiments may be implemented individually or in any combination.

What is claimed is:

1. A method of operating a server, comprising:
forwarding, to a second user equipment (UE) device and a third UE device, a cryptographic key transmitted by a first UE device to terrestrial-based communications equipment, the first UE device being associated with a first user identifier and the second and third UE devices being associated with a second user identifier different from the first user identifier; and
forwarding, to the second UE device and the third UE device, a message transmitted by the first UE device to a satellite constellation, the message being encrypted by the first UE device using the cryptographic key.

2. The method of claim 1, wherein the message comprises a handle index and a handle assignment bit, the method further comprising:
forwarding the message to the second UE device and the third UE device based on the handle index and the handle assignment bit.

3. The method of claim 2, wherein the message further comprises a handle associated with the second user identifier, the handle is shorter than the second user identifier, and the method further comprises:
responsive to the handle assignment bit having a predetermined value, storing information mapping the handle index to the handle.

4. The method of claim 1, further comprising:
forwarding a first acknowledgment to the cryptographic key from the second UE device to the first UE device via the terrestrial-based communications equipment; and
forwarding a second acknowledgment to the cryptographic key from the third UE device to the first UE device via the terrestrial-based communications equipment.

5. The method of claim 1, further comprising:
forwarding a first additional cryptographic key from the second UE device to the first UE device via the terrestrial-based communications equipment; and
forwarding a second additional cryptographic key from the third UE device to the first UE device via the terrestrial-based communications equipment.

6. The method of claim 1, wherein the terrestrial-based communications equipment comprises a wireless base station or a wireless access point.

7. A method of operating a server, comprising:
receiving, using a communications interface with a satellite constellation, a first message transmitted by a first user equipment (UE) device, wherein the first message comprises a handle associated with a second UE device, a handle index associated with the handle, and a handle assignment bit having a first value;
storing, at storage circuitry, information mapping the handle index to the handle; and
forwarding the first message to the second UE device via a terrestrial network.

8. The method of claim 7, wherein the handle uniquely identifies the second UE device but is smaller than a corresponding unique user identifier associated with the second UE device.

9. The method of claim 7, further comprising:
receiving, using the communications interface with the satellite constellation, a second message transmitted by the second UE device, wherein the second message comprises the handle index and the handle assignment bit but not the handle, the handle assignment bit in the second message having a second value that is different than the first value.

10. The method of claim 9, wherein the handle index comprises between 1 and 8 bits and wherein the handle assignment bit precedes the handle in the second message.

11. The method of claim 9, further comprising:
identifying the handle based on the handle index in the second message and based on the stored information;
identifying a destination address of the second UE device based on the identified handle; and
forwarding the second message to the identified destination address.

12. The method of claim 9, wherein the handle index is shorter than the handle.

13. The method of claim 12, wherein the handle assignment bit precedes the handle index in the first message and wherein the handle index precedes the handle in the first message.

14. The method of claim 11, wherein the handle index comprises at least three bits.

15. A method of operating a server, comprising:
receiving, using a communications interface with terrestrial-based communications equipment, a set of different satellite communications status message payloads transmitted by a first user equipment (UE) device to the terrestrial-based communications equipment;
storing, at storage circuitry, the set of different satellite communications status message payloads; and
receiving, using a communications interface with a satellite constellation, a control message transmitted by the first UE device to the satellite constellation, wherein the control message identifies a particular satellite communications status message payload from the set of different satellite communications status message payloads stored at the storage circuitry.

16. The method of claim 15, further comprising:
receiving, using the communications interface with the satellite constellation, a message intended for a second UE device that was transmitted by the first UE device; and
transmitting, to the second UE device via a terrestrial network, the message and the particular satellite communications status message payload identified by the control message.

17. The method of claim 16, wherein the particular satellite communications status message payload is double-encrypted by the first UE device, the control message comprises a cryptographic key, and the method further comprises:
decrypting the particular satellite communications status message payload using the cryptographic key to recover a single-encrypted satellite communications status message payload; and
transmitting, to the second UE device via the terrestrial network, the single-encrypted satellite communications status message payload.

18. The method of claim 15, wherein storing the set of different satellite communications status payloads comprises storing payload identifiers for each of the different satellite communications status payloads and wherein the control message comprises one of the payload identifiers.

19. The method of claim 15, wherein the terrestrial-based communications equipment comprises a wireless base station or a wireless access point.

20. The method of claim 15, further comprising:
transmitting, to a second UE device via a terrestrial network, the particular satellite communications status message payload identified by the control message.
